(19) United States
(12) Patent Application Publication
(10) Pub. No.: US 2017/0201940 A1
(43) Pub. Date: Jul. 13, 2017

(54) DYNAMIC DELIVERY TRAFFIC INDICATION MESSAGE IMPLEMENTATIONS

(71) Applicant: QUALCOMM Incorporated, San Diego, CA (US)

(72) Inventors: Praveen Koratekere Honnappa, San Diego, CA (US); Ramesh Venkatachalam, San Diego, CA (US); Yashavant Anuse, San Diego, CA (US); Pradeep Kumar Yenganti, Cupertino, CA (US)

(21) Appl. No.: 14/990,578

(22) Filed: Jan. 7, 2016

(51) Int. Cl. H04W 52/02; H04L 12/18; H04W 24/08

(52) U.S. Cl. CPC H04W 52/0206; H04W 24/08; H04L 12/189; H04W 88/08

(57) ABSTRACT

Systems, methods, and apparatuses for dynamic delivery traffic indication message (DTIM) implementations in a wireless communications network are described. In various examples, an access point (AP) may adjust a DTIM period over time based on various criteria, and indicate the adjustment of the DTIM period to stations being served by the AP. A station may adjust its listening period for DTIMs in response to the indication, and update the listening period based on subsequent indications. By adjusting the DTIM period over time, a wireless communications system may more effectively balance performance considerations including latency, power consumption, and synchronization associated with broadcast and/or multicast communications.

### BACKGROUND

The following relates generally to wireless communication, and more specifically to dynamic delivery traffic indication message (DTIM) implementations.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless network, for example a wireless local area network (WLAN), may include an access point (AP) that may communicate with one or more stations or other mobile devices. The AP may be coupled to another network, such as the Internet, and may enable a mobile device to communicate via the wireless network or the other network (e.g., communicate with other devices coupled to the AP via the wireless network or the other network). A wireless communication device may communicate with a network device bi-directionally. For example, in a WLAN, a station may communicate with an associated AP via downlink (DL) and uplink (UL) communication links. The DL (or forward link) may refer to the communication link from the AP to the station, and the UL (or reverse link) may refer to the communication link from the station to the AP.

To indicate that an AP has broadcast and/or multicast data to be transmitted to stations being served by the AP over the wireless network, the AP may periodically broadcast a DTIM according to a DTIM period for the AP. DTIMs may be a form of a traffic indication message (TIM) information element (IE), which may be transmitted by an AP over a beacon signal. A DTIM may contain a data field that indicates which stations have broadcast and/or multicast traffic buffered at the AP. A station may be configured with a DTIM listening interval to receive DTIMs.

### SUMMARY

Systems, methods, and apparatuses for dynamic DTIM implementations in a wireless communications network are described. In various examples, an AP may adjust a DTIM period over time based on various criteria, and indicate the adjustment of the DTIM period to stations being served by the AP. By adjusting the DTIM period over time, a wireless communications system may more effectively balance performance considerations including latency, power consumption, and synchronization associated with broadcast and/or multicast communications.

For example, an AP may begin by operating in a first state associated with a first DTIM period. Accordingly, stations being served by the AP may operate in a power management mode (e.g., a power-save or reduced-power mode) associated with listening for DTIMs according to the first DTIM period. When an amount of broadcast and/or multicast traffic changes, the AP may switch from the first state associated with the first DTIM period to a second state associated with a second DTIM period. The AP may provide an indication to stations being served by the AP that the DTIM period has changed to the second DTIM period. When a station that supports dynamic DTIM implementations receives the indication, the station may adjust a power-save algorithm to listen according to the second DTIM period.

A method of wireless communication is described. The method may include identifying, at an access point, a first delivery traffic indication message (DTIM) period, monitoring traffic at the access point for a first time period, and switching to a second DTIM period based at least in part on a comparison of the monitored traffic during the first time period to a first traffic threshold.

An apparatus for wireless communication is described. The apparatus may include means for identifying, at an access point, a first DTIM period, means for monitoring traffic at the access point for a first time period, and means for switching to a second DTIM period based at least in part on a comparison of the monitored traffic during the first time period to a first traffic threshold.

Another apparatus is described. The apparatus may include a processor, memory in electronic communication with the processor, and instructions stored in the memory. The instructions may be executable by the processor to cause the apparatus to identify, at an access point, a first DTIM period, monitor traffic at the access point for a first time period, and switch to a second DTIM period based at least in part on a comparison of the monitored traffic during the first time period to a first traffic threshold.

A non-transitory computer readable medium for wireless communication is described. The non-transitory computer-readable medium may include instructions executable by a processor to identify, at an access point, a first DTIM period, monitor traffic at the access point for a first time period, and switch to a second DTIM period based on a comparison of the monitored traffic during the first time period to a first traffic threshold.

Some examples of the method, apparatuses, or non-transitory computer-readable medium may include steps, features, means, or instructions for transmitting a set of DTIMs in a set of beacon frames according to the second DTIM period.

In some examples of the method, apparatuses, or non-transitory computer-readable medium, switching to the second DTIM period may include steps, features, means, or instructions for determining that a value representing the monitored traffic for the first time period is below the first traffic threshold, and switching to the second DTIM period, the second DTIM period being longer than the first DTIM period.

In some examples of the method, apparatuses, or non-transitory computer-readable medium, determining that the value representing the monitored traffic for the first time period is below the traffic threshold may include steps, features, means, or instructions for identifying an absence of the traffic for the access point to attempt to transmit to one or more stations.

Some examples of the method, apparatuses, or non-transitory computer-readable medium may include steps, features, means, or instructions for detecting traffic at the access point during a second time period, and switching back to the first DTIM period based on detecting the traffic during the second time period.

Some examples of the method, apparatuses, or non-transitory computer-readable medium may include steps, features, means, or instructions for monitoring traffic at the access point for a second time period, and switching to a third DTIM period based on a second comparison of the monitored traffic during the second time period to a second traffic threshold, the third DTIM period being longer than the second DTIM period.

In some examples of the method, apparatuses, or non-transitory computer-readable medium, switching to the second DTIM period may include steps, features, means, or instructions for determining that a value representing the monitored traffic for the first time period is above the first traffic threshold, and switching to the second DTIM period, the second DTIM period being shorter than the first DTIM period.

In some examples of the method, apparatuses, or non-transitory computer-readable medium, determining that the value representing the monitored traffic for the first time period is above the first traffic threshold may include steps, features, means, or instructions for identifying traffic at the access point.

Some examples of the method, apparatuses, or non-transitory computer-readable medium may include steps, features, means, or instructions for generating a DTIM period value according to the second DTIM period, and transmitting the DTIM period value.

Some examples of the method, apparatuses, or non-transitory computer-readable medium may include steps, features, means, or instructions for determining that a DTIM count is zero. In some examples of the method, apparatuses, or non-transitory computer-readable medium, transmitting the DTIM period value may include steps, features, means, or instructions for transmitting the DTIM period value based on determining that the DTIM count is zero.

In some examples of the method, apparatuses, or non-transitory computer-readable medium, the second DTIM period is an integer multiple of the first DTIM period.

A method of wireless communication is described. The method may include listening, at a station, for a DTIM according to a first DTIM listening interval, receiving an indication of a second DTIM listening interval, and switching from listening according to the first DTIM listening interval to listening according to the second DTIM listening interval based at least in part on the indication.

An apparatus for wireless communication is described. The apparatus may include means for listening, at a station, for a DTIM according to a first DTIM listening interval, means for receiving an indication of a second DTIM listening interval, and means for switching from listening according to the first DTIM listening interval to listening according to the second DTIM listening interval based at least in part on the indication.

Another apparatus is described. The apparatus may include a processor, memory in electronic communication with the processor, and instructions stored in the memory. The instructions may be executable by the processor to cause the apparatus to listen, at a station, for a DTIM according to a first DTIM listening interval, receive an indication of a second DTIM listening interval, and switch from listening according to the first DTIM listening interval to listening according to the second DTIM listening interval based at least in part on the indication.

A non-transitory computer readable medium for wireless communication is described. The non-transitory computer-readable medium may include instructions executable by a processor to listen, at a station, for a DTIM according to a first DTIM listening interval, receive an indication of a second DTIM listening interval, and switch from listening according to the first DTIM listening interval to listening according to the second DTIM listening interval based on the indication.

Some examples of the method, apparatuses, or non-transitory computer-readable medium may include steps, features, means, or instructions for determining a wake-up configuration of the station based on the second DTIM listening interval.

Some examples of the method, apparatuses, or non-transitory computer-readable medium may include steps, features, means, or instructions for receiving a second indication of a third DTIM listening interval, and switching from listening according to the second DTIM listening interval to listening according to the third DTIM listening interval based on the second indication.

In some examples of the method, apparatuses, or non-transitory computer-readable medium, the second DTIM listening interval is longer than the first DTIM listening interval. In some examples of the method, apparatuses, or non-transitory computer-readable medium, the second DTIM listening interval is an integer multiple of the first DTIM listening interval. In some examples of the method, apparatuses, or non-transitory computer-readable medium, listening for a DTIM may include steps, features, means, or instructions for decoding a portion of a beacon frame transmitted by an access point.

In some examples of the method, apparatuses, or non-transitory computer-readable medium, receiving the indication of the second DTIM listening interval may include steps, features, means, or instructions for receiving a DTIM count information element, or a DTIM period information element, or a combination thereof.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

FIG. 1 illustrates an example of a wireless communications system that supports dynamic delivery traffic indication message (DTIM) implementations, in accordance with aspects of the present disclosure;

FIG. 2 illustrates a TIM information element frame format for wireless communication, in accordance with aspects of the present disclosure;

FIG. 3 illustrates a TIM transmission sequence having a dynamic DTIM period, in accordance with aspects of the present disclosure;

FIG. 4 illustrates a process flow for providing dynamic DTIM implementations at an access point (AP), in accordance with aspects of the present disclosure;

FIG. 5 illustrates a process flow for providing dynamic DTIM implementations at a station, in accordance with aspects of the present disclosure;

FIGS. 6 through 8 show block diagrams of wireless communication devices that support dynamic DTIM implementations in accordance with aspects of the present disclosure;

FIG. 9 illustrates a block diagram of a system including a AP that supports dynamic DTIM implementations in accordance with aspects of the present disclosure;

FIGS. 10 through 12 show block diagrams of wireless communication devices that support dynamic DTIM implementations in accordance with aspects of the present disclosure;

FIG. 13 illustrates a block diagram of a system including a station that supports dynamic DTIM implementations in accordance with aspects of the present disclosure; and

FIGS. 14 and 15 illustrate methods for dynamic DTIM implementations in accordance with aspects of the present disclosure.

### DETAILED DESCRIPTION

To indicate that an access point (AP) has broadcast and/or multicast data to be transmitted to stations being served by the AP, the AP may periodically broadcast a delivery traffic indication message (DTIM). The DTIMs may be periodically transmitted according to a DTIM period assigned at the AP. To receive DTIMs, a station may be configured with a DTIM listening interval. The DTIM listening interval may correspond to a DTIM period assigned at the AP, and subsequently transmitted to and received by the station during an establishment of communications with the AP. According to the DTIM listening interval, a station may wake up certain components in order to receive DTIMs from the AP.

To reduce power consumption, a station may be configured with a listening interval that is longer than the DTIM period assigned at the AP. Such a configuration may reduce power consumption at the station, but may also degrade communication performance due to the lack of synchronization between the DTIM listening interval and DTIM transmissions. For example, if a DTIM listening interval of a station is longer than the DTIM period assigned at the AP, the station may miss an indication that broadcast and/or multicast traffic will be delivered to the station, and subsequently not receive the broadcast and/or multicast traffic. A longer DTIM period may be set at the AP, but the various devices of the network may suffer from increased latency associated with broadcast and/or multicast traffic. Therefore, some DTIM implementations do not fully address the tradeoffs between broadcast and/or multicast communication latency, power consumption, and device synchronization.

According to aspects of the present disclosure, an AP may adjust a DTIM period over time based on various criteria, and indicate the adjustment in DTIM period to stations being served by the AP. By adjusting the DTIM period over time, a wireless communications system may more effectively balance performance considerations including latency, power consumption, and synchronization associated with broadcast and/or multicast communications.

For example, an AP may begin by operating in a first state associated with a first DTIM period. Accordingly, stations being served by the AP may listen for DTIMs according to the first DTIM period. For example, the station may operate in a power-save mode, listening for DTIMs according to the first DTIM period, but not during other time periods. When an amount of broadcast and/or multicast traffic changes, the AP may switch from the first state associated with the first DTIM period to a second state associated with a second DTIM period. The AP may provide an indication to stations being served by the AP that the DTIM period has changed to the second DTIM period. When a station that supports dynamic DTIM implementations receives the indication, the station may adjust its listening behavior to listen according to the second DTIM period. In some examples, the station may adjust its power-save configuration in response to the indication.

In some examples, an AP can be configured to have three or more DTIM periods. In an example with three DTIM periods, the three DTIM periods may be associated with a minimum value, an intermediate value, and a maximum value (which may also be referred to herein as MinDTIM, TransDTIM, and MaxDTIM, respectively). The AP may default to operate according to the minimum value, which may be a legacy value, or a value that is otherwise supported by stations that are not configured to operate with a dynamic DTIM implementation. One or both of the intermediate value and the maximum value may be an integer multiple of the minimum value, such that stations that do not support dynamic DTIM implementations may still receive each DTIM transmission from an AP, despite the stations sometimes listening for DTIMs when a DTIM has not been transmitted by the AP.

An AP may begin by operating in a first state associated with a DTIM period equal to a minimum value (e.g., MinDTIM), and stations being served by the AP may operate in a power-save mode associated with listening for DTIMs according to MinDTIM. The AP may continue operating in the first state while broadcast and/or multicast traffic continues to be buffered at the AP. When the traffic drops below a threshold, such as a low amount of traffic determined to be under the threshold for a predetermined period of time, or an absence of traffic for a predetermined period of time, the AP may switch from the first state associated with MinDTIM to a second state associated with an intermediate DTIM period (e.g., TransDTIM).

The AP may provide an indication to stations being served by the AP that the DTIM period has changed. For example, the AP may transmit an indication in a DTIM period data field or a DTIM count data field of a TIM IE. When a station that supports dynamic DTIM implementations receives the indication, the station may adjust a power management mode (e.g., a power-save mode or a reduced power mode) to listen according to the longer interval associated with a DTIM period equal to the intermediate DTIM period. Thus, the AP may transmit DTIMs less frequently, and stations being served by the AP may also listen to DTIMs less frequently, according to a longer interval, and therefore reduce power consumption as a result of a longer sleep duration between DTIM listening periods.

In cases where an AP is serving stations that do not support dynamic DTIM implementations, those stations may continue to listen according to the minimum DTIM period. The stations may wake up to listen to DTIMs more frequently than the AP is transmitting DTIMs, but may still receive the DTIMs that are transmitted by the serving station.

The AP may continue operating in the second state while broadcast and/or multicast traffic at the AP remains below a threshold. When traffic drops below a threshold, for example where the AP determines that it continues to lack traffic for a second period of time, the AP may switch from the second state associated with the intermediate DTIM period to a third state associated with a maximum DTIM period (e.g., MaxDTIM). The AP can provide an indication to stations being served by the AP that the DTIM period has changed, for example to MaxDTIM. When a station that supports dynamic DTIM implementations receives the indication, the station may adjust a power management mode to listen at the longer interval associated with MaxDTIM. Thus, the AP may transmit DTIMs even less frequently, and stations being served by the AP may also listen to DTIMs even less frequently and according to an even longer interval, and further reduce power consumption as a result of the even longer sleep duration.

If traffic at the AP exceeds a threshold while operating in either the second state or the third state, the AP may revert to the first state associated with the minimum DTIM period (e.g., MinDTIM). For example, if the AP detects traffic for broadcast and/or multicast transmission to one or more stations served by the AP, the AP may immediately set the DTIM period to the minimum DTIM period, and indicate the change to the stations served by the AP. In some examples this transition back to the first state may reduce latency associated with subsequent broadcast and/or multicast transmissions in comparison to continuing to transmit DTIMs according to the second state or the third state. Although the previous example is described according to three DTIM periods, it should be understood that the concepts described above and elsewhere in the present disclosure can be applied to any number of DTIM periods, which may or may not be bound by a particular minimum value or a particular maximum value.

Aspects of the disclosure are initially described in the context of a wireless communication system. These and other aspects of the disclosure are further illustrated by and described with reference to apparatus diagrams, system diagrams, and flowcharts that relate to dynamic delivery traffic indication message implementations.

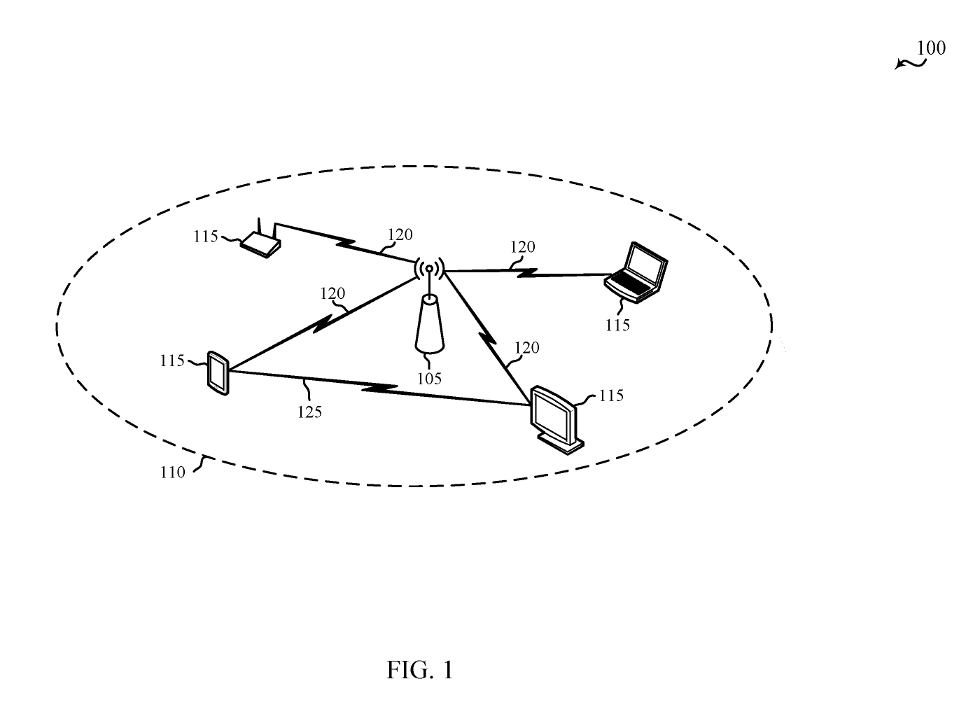

FIG. 1 illustrates an example of a wireless communication system 100 that supports dynamic DTIM implementations, in accordance with aspects of the present disclosure. The wireless communication system 100 may be a wireless local area network (WLAN) that includes an AP 105 and multiple associated stations 115. The stations 115 may represent devices such as mobile stations, personal digital assistant (PDAs), other handheld devices, netbooks, notebook computers, tablet computers, laptops, display devices (e.g., TVs, computer monitors, etc.), printers, etc. The various stations 115 in the network are able to communicate with one another through the AP 105, including communications over communication links 120 that are established between the AP 105 and stations 115 served by the AP 105. The AP 105 may be connected to an external network (not shown), such as a core network, a local intranet, the Internet, or any other network suitable for communicating with the AP 105 or the stations 115. Also shown is a coverage area 110 of the AP 105, which may represent a basic service area (BSA) of the wireless communication system 100. In some examples, the coverage area 110 of an AP 105 may be divided into sectors (not shown).

Although not shown in FIG. 1, a station 115 may be located in the intersection of more than one coverage area 110 and may associate with more than one AP 105. A single AP 105 and an associated set of stations 115 may be referred to as a basic service set (BSS). An extended network station (not shown) associated with the wireless communication system 100 may be connected to a wired or wireless distribution system that may allow multiple APs 105 to be connected in an extended service set (ESS), wherein an ESS may refer to a set of connected BSSs. A distribution system (not shown) may be used to connect APs 105 in an ESS.

The wireless communication system 100 may include one or more APs 105 of different types (e.g., metropolitan area, home network, etc.), with varying and overlapping coverage areas 110. In some examples of the wireless communication system 100, two stations 115 may communicate directly via a direct wireless link 125 regardless of whether both stations 115 are in the same coverage area 110. Examples of direct wireless links 125 may include Wi-Fi Direct connections, Wi-Fi Tunneled Direct Link Setup (TDLS) links, and other group connections. Stations 115 and APs 105 may communicate according to the WLAN radio and baseband protocol for physical and media access control (MAC) layers from Institute of Electrical and Electronics Engineers (IEEE) 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within the wireless communication system 100.

In some examples of the wireless communication system 100, an AP 105 may receive traffic that is intended for broadcast and/or multicast transmission to one or more stations 115 served by the AP 105. To indicate that the AP 105 has buffered broadcast and/or multicast traffic, the AP 105 may periodically broadcast a delivery traffic indication message (DTIM). DTIMs may be a form of a traffic indication message (TIM) information element (IE) transmitted over a beacon signal, and may contain a data field that indicates which stations have broadcast and/or multicast traffic buffered at the AP 105.

To receive DTIMs, a station 115 may be configured with a DTIM listening interval, which may correspond to a DTIM period assigned at the AP 105. In some examples the DTIM period assigned at the AP may be communicated to the station during an establishment of a communication link with the AP 105, and the station 115 may subsequently set the DTIM listening interval equal to the communicated DTIM period. According to the DTIM listening interval, a station may wake up certain components in order to receive DTIMs from the AP. When a station 115 receives a DTIM indicating that broadcast and/or multicast traffic intended for the station will be transmitted by the AP 105, the station 115 can be configured to listen for such traffic and decode the incoming broadcast and/or multicast transmissions from the AP 105.

According to aspects of the present disclosure, an AP 105 may adjust a DTIM period over time based on various criteria, such as a change in an amount of traffic buffered at the AP 105 for broadcast and/or multicast transmission to stations 115 being served by the AP 105. For example, an AP may begin by operating in a first state associated with a first DTIM period. When an amount of broadcast and/or multicast traffic changes, the AP may switch from the first state associated with the first DTIM period to a second state associated with a second DTIM period. In the event that an AP 105 changes to a different DTIM period, the AP 105 may provide an indication of the DTIM period adjustment in a manner that may be received by those stations 115 being served by the AP 105. By adjusting the DTIM period over time and communicating the adjustment to stations 115, an AP 105 may more effectively balance performance considerations including latency, power consumption, and synchronization associated with broadcast and/or multicast communications

A station 115 may employ a power management algorithm (e.g., a power management mode, power-save mode, reduced-power mode, etc.) that includes a sleep mode, where various components of the station 115 are operated in a low-power or powered-down condition. If a station 115 enters a sleep mode, the station 115 may wake according to the DTIM listening interval to receive DTIMs from a serving AP 105. The station 115 may wake sufficiently early to activate the radio components used for DTIM reception. In some cases, the station 115 may also wake early to account for possible timing asynchronization with the AP 105. If the station 115 does not receive a DTIM from the AP 105 at the expected time, the station 115 may wait for a beacon miss timer to expire. If a DTIM (or a standard TIM) is received from the AP 105, the station 115 may then wait for the indicated transmission until a content-after-beacon (CAB) timer expires. If either timer expires, the station 115 may re-enter sleep mode and wait for the next anticipated DTIM or TIM transmission.

According to aspects of the present disclosure, a station 115 may receive an indication from an AP 105 serving the station 115 that the DTIM period of the AP 105 has changed. The change may, for example, result from a change in a level of traffic buffered for broadcast and/or multicast transmission by the AP 105. In some examples a station 115 may support dynamic DTIM implementations, in which case the station 115 may adjust a power management algorithm to listen for DTIMs according to the new DTIM period (e.g., adjusting a DTIM listening interval according to the received indication of a new DTIM period). Thus, by adjusting the DTIM listening interval over time, a station 115 may more effectively balance performance considerations including latency, power consumption, and synchronization associated with broadcast and/or multicast communications.

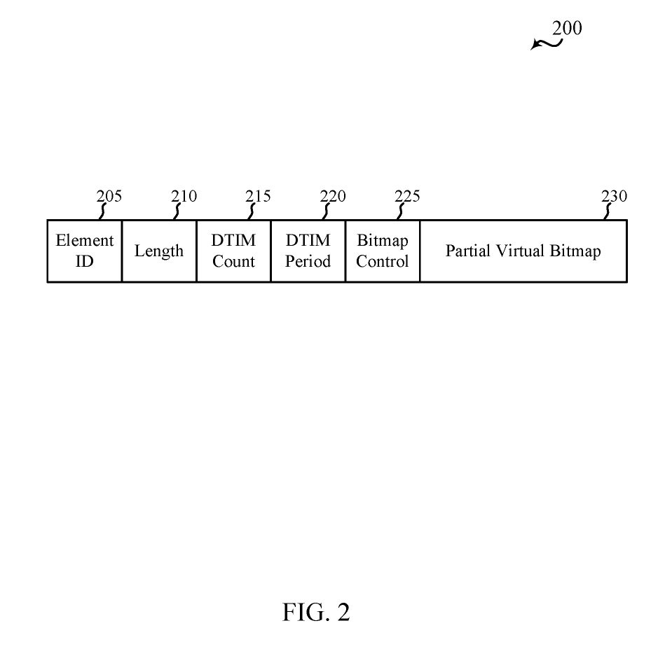

FIG. 2 illustrates a TIM information element frame format 200 for wireless communication, in accordance with aspects of the present disclosure. The TIM information element may be used to indicate that an AP 105 has buffered frames awaiting transmission for various stations 115 being served by the AP 105. In order to facilitate various aspects of discovery and information flow, TIM information elements may be transmitted by an AP 105 on beacon signals so that stations 115 served by the AP 105 can interpret such aspects as a listening interval. A listening interval may be implemented by various stations 115 in a wireless communication system. The listening interval may define protocols of a power management mode such as a sleep protocol or a wake-up configuration. For example, the intervals associated with beacon transmissions (e.g. TIMs) may be used to define intervals in which various portions of a station may operate in various modes (e.g., an awake mode, a sleep mode, a wake-up configuration, etc.). A DTIM may be a certain form of TIM where the indication of buffered frames awaiting transmission are associated with broadcast and/or multicast transmissions by an AP 105. The TIM information element frame format 200 may, for example, be defined according to one or more IEEE 802.11 standard.

The element ID field 205 of the TIM information element frame format 200 may include an indication of the information element type. For example an element ID having a certain value may indicate that the information element is a TIM information element. The length field 210 of the TIM information element frame format 200 may include an indication of the length of the associated information field (e.g., the length of a partial virtual bitmap field).

The DTIM count field 215 of the TIM information element frame format 200 may provide an indication of how many beacon frames (including the current frame) appear before the next DTIM transmission. The DTIM count may be an integer value, and may be decremented from an initial DTIM count value associated with the DTIM period. For example, for a DTIM period of 4, the DTIM count may initialize at a value of 3, and at each TIM transmission (e.g., each beacon transmission), the DTIM value may count down by one until reaching zero. In other words, the DTIM count in successive TIM transmissions may be 3, followed by 2, followed by 1, and then finally by 0. A DTIM count of 0 may indicate that the present TIM is a DTIM, which may contain an indication that the AP 105 has buffered frames awaiting broadcast and/or multicast transmission to various stations 115 served by the AP 105. Following a beacon frame that includes a DTIM, an AP 105 may release the buffered broadcast and/or multicast data, if any exists. The DTIM count value may then be re-initialized to an initial value, associated with the subsequent DTIM period, which according to aspects of the present disclosure, may or may not be the same as the previous initial DTIM count value.

The DTIM period field 220 of the TIM information element frame format 200 may be a single octet that reflects the number of TIM intervals between DTIM frames, which may reflect a number of beacon transmissions between DTIM transmissions. For example, a DTIM period of 4 may indicate that a DTIM will be transmitted by an AP 105 as a portion of every fourth beacon transmission. A value of 1 may indicate that every TIM is a DTIM, which may indicate that every beacon transmission includes a DTIM.

The bitmap control field 225 of the TIM information element frame format 200 may be a single octet, reflecting an offset. The first bit of the field may contain the traffic indicator bit associated with an association identifier (AID), where the AID may represent a logical port of an AP 105 that is assigned to a station 115. This bit may be set to 1 in the TIM elements with a value of 0 in the DTIM count field when one or more broadcast and/or multicast frames are buffered at an AP 105. The remaining bits of the field form a bitmap offset, which may be used to indicate a position of a first non-zero bit in partial virtual bitmap field 230.

The partial virtual bitmap field 230 of the TIM information element frame format 200 may provide a per-station indication of AP frame buffer status. The partial virtual bitmap field 230 may comprise a number of bits that identify traffic buffered for one or more stations within the BSS that an AP 105 is prepared to deliver at the time the beacon frame is transmitted.

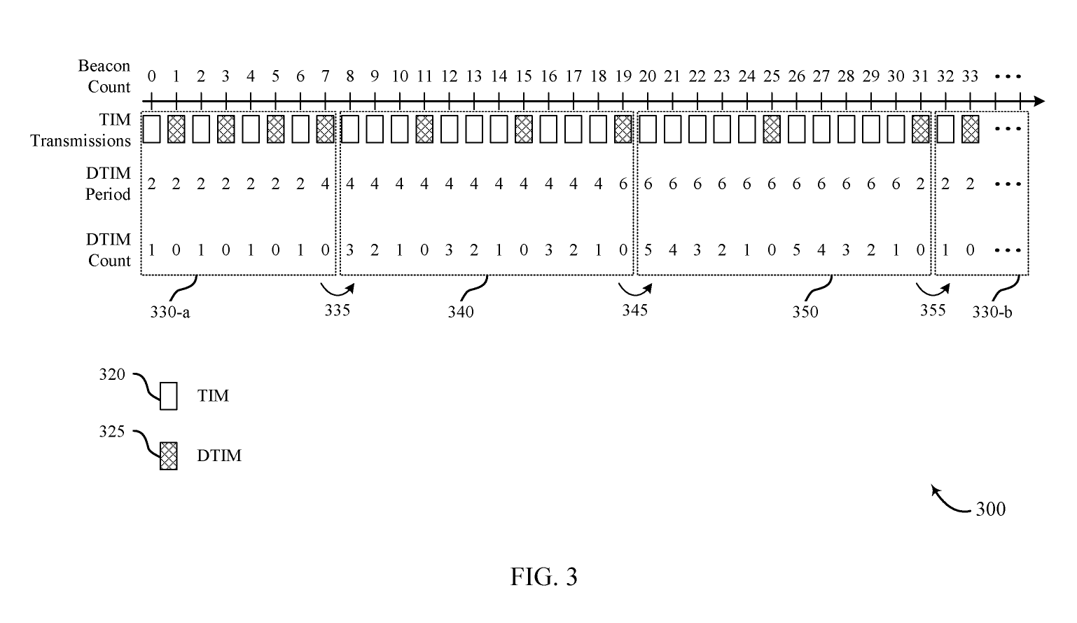

FIG. 3 illustrates a TIM transmission sequence 300 having a dynamic DTIM period, in accordance with aspects of the present disclosure. The TIM transmission sequence 300 may include a sequence of TIMs 320 and DTIMs 325 to be transmitted from an AP 105, where the DTIMs 325 may be a type of TIM information element. The TIMs and DTIMs may, for example, follow the TIM information element frame format 200 described with reference to FIG. 2. The TIMs may be broadcast on beacon signals from an AP 105, and may be received by one or more stations 115 within a transmission range of the AP 105. Although the TIM transmission sequence 300 is shown with reference to beacon counts from 0 to 33, the use of beacon counts is merely intended to provide a reference for successive beacon transmissions as they may relate to an example of a dynamic DTIM implementation.

As shown, TIM transmission sequence 300 comprises TIMs 320 and DTIMs 325, which may each form at least a portion of a beacon transmission at a periodic beacon interval. As previously described with reference to the TIM information element frame format 200, each TIM may include an associated DTIM period, where the DTIM period is associated with a number of beacon intervals between DTIM transmissions, and a DTIM count which resets to an initial value after each DTIM transmission, and decrements at each TIM transmission (which may be at each beacon transmission). In some examples, such as TIM transmission sequence 300, DTIMs may be transmitted at each instance where DTIM count is equal to zero.

TIM transmission sequence 300 may begin by operating in a first state 330 (e.g., first state 330-a), corresponding to a DTIM period of 2. In other words, the first state 330 can be associated with an operating mode where DTIMs 325 are transmitted every other beacon count. As previously described, the first state may correspond to a minimum DTIM period (e.g., MinDTIM). During the first state 330, an AP may be configured to assign a value of 2 to the DTIM period field of each TIM information element. The AP may also assign an initial value of 1 to the DTIM count field, such as at beacon counts 0, 2, 4, and 6, and decrement the DTIM count by one at each TIM information element transmission. Thus, in the first state 330, the DTIM count field of successive TIM information elements may alternate between values of 1 and 0 as shown.

When the DTIM count has a value of 0 (e.g., beacon counts 1, 3, 5, and 7 illustrated in FIG. 3), the AP 105 may transmit a DTIM 325, which may indicate whether the AP 105 has buffered traffic awaiting broadcast and/or multicast transmission from the AP 105 to various stations 115 served by the AP 105. The AP 105 can associate various values in the DTIM 325 with stations 115, such as bit locations in the partial virtual bitmap field 230 of the TIM information element frame format 200 described with reference to FIG. 2. Following the transmission of a DTIM 325, the AP may subsequently release the buffered traffic for broadcast and/or multicast transmission.

Stations 115 that are served by an AP 105 associated with the TIM transmission sequence 300 may utilize the TIM transmissions for various aspects of power saving modes. For example, a station 115 may initialize a connection with the AP 105, and use portions of the TIM IE to determine a timing for a transmission of a subsequent DTIM 325, and to determine a DTIM listening interval according to a DTIM period. In some examples, after initializing a connection, a station 115 may operate in a sleep mode during TIM transmissions, and transition to an awake mode to listen for DTIM transmissions. The awake mode may, for example, be associated with powering up various components such as a receiver, a demodulator, and/or a digital signal processor. In this manner, each station 115 can listen for DTIMs 325 according to a DTIM listening interval, and identify whether a serving AP 105 has broadcast and/or multicast data traffic to send to the respective station 115.

From beacon counts 7 to 8, the TIM transmission sequence 300 may undergo a first transition 335, where the TIM transmission sequence 300 switches from the first state 330 to a second state 340. The second state 340 can, for example, correspond to a DTIM interval of 4. In other words, the second state 340 can be associated with an operating mode where DTIMs 325 are transmitted every fourth beacon count.

In some examples, the first transition 335 may be triggered by a traffic condition at an AP 105. For instance, an AP 105 may have a low amount of traffic (e.g., a lack of traffic, or a lack of traffic for a predetermined amount of time) buffered for broadcast and/or multicast transmission to stations 115 served by the AP 105. Therefore, upon determining a low amount of traffic, the first transition 335 can be associated with an increase in DTIM period. The new DTIM period associated with the second state 340 may be a pre-assigned intermediate value associated (e.g., TransDTIM), or the new DTIM period may be a calculated value based on such parameters as an amount of buffered data, data rates, types of stations served by an access point, power conditions of stations served by the access point, or the like.

In some examples, an AP 105 may provide an indication of the first transition 335. For example, in the DTIM 325 associated with the beacon count 7, the AP 105 may assign the new value of DTIM period (e.g., changing DTIM period from 2 to 4 at beacon count 7). In this manner the AP 105 can provide an indication as part of a DTIM 325 that stations 115 may already have awakened to listen to. In other examples, DTIM period may be updated to a new value at any time suitable for stations 115 served by the AP 105 to reconfigure a listening interval. In some examples the DTIM count field may be used to identify the first transition 335. For example, in the first state 330, an AP 105 may assign an initial value of DTIM count equal to 1, and in the second state the AP 105 may assign an initial value of DTIM count equal to 3. Therefore, stations 115 that receive the TIM transmission sequence 300 may be able to identify the first transition 335 by decoding the TIM 320 following the transmission of a DTIM 325 (e.g., decoding the DTIM count data field of the TIM 320 at beacon count 8), and associate the DTIM count value of 3 with a DTIM period of 4. When an AP 105 is configured to provide the indication of the first transition 335 by a change in the DTIM count field, the AP 105 may, in some examples, continue to broadcast DTIM period equal to 2. In doing so, the AP 105 may continually communicate the minimum value (e.g., MinDTIM), so that stations 115 that do not support dynamic DTIM implementations may be able to initialize to the minimum value to avoid missing DTIM transmissions when longer DTIM periods are employed. In some examples, an AP 105 may provide an indication of the first transition 335 through other mechanisms, such as an indication included in an information element other than a TIM 320 or DTIM 325.

When an AP 105 switches to a state with a longer DTIM interval, a station 115 being served by the AP 105 may be able to reduce power consumption by way of a power management mode (e.g., a power-save mode or a reduced power mode). For example, upon receiving an indication that DTIM period has increased, the station 115 may increase a listening interval. In some examples, station 115 may spend a longer duration in a sleep mode based at least in part on the increased listening interval. The longer duration in a sleep mode may be associated with operating components, for example a receiver, a demodulator, a digital signal processor (DSP), etc., at a low-power or powered-down mode for a longer duration, before station 115 wakes up those components into a listening mode to receive DTIM transmissions.

In some examples, the first state 330 may be associated with a legacy DTIM period, or a DTIM period that is otherwise supported by stations 115 which are not configured to support dynamic DTIM implementations. In some examples a legacy DTIM period may refer to a DTIM interval associated with a static DTIM implementation. In examples where the first state 330 is associated with a legacy DTIM period, it may be advantageous for the DTIM period of the second state 340 to be an integer multiple of the DTIM period of the first state.

For example, a legacy station 115 (e.g., a station 115 that does not support dynamic DTIM implementations) may initialize a connection with a DTIM period of 2, and thus employ a static DTIM listening interval of 2 TIM periods and/or 2 beacon intervals throughout its operation. During the first state 330, the legacy station 115 may listen for DTIMs at each of the odd beacon counts (e.g., beacon counts 1, 3, 5, and 7). During the second state 340, the legacy station 115 may continue listening to each of the odd beacon counts (e.g., beacon counts 9, 11, 13, 15, 17, and 19). Thus, the legacy station 115 may wake up at intervals that are not associated with a DTIM transmission (e.g., beacon counts 9, 13, and 17). However, although the legacy station 115 may wake up more frequently to receive each DTIM 325 in the TIM transmission sequence 300, the legacy station 115 would not miss DTIMs 325 because of the integer multiple between the DTIM period associated with the first state 330 and the DTIM period associated with the second state 340. If, for example, the DTIM period of the second state 340 was 3, the AP 105 would transmit DTIMs 325 at beacon counts 10, 13, 16, 19, and so on, and a legacy station 115 that did not support dynamic DTIM implementations may miss every other DTIM 325 (e.g., DTIM 325 transmissions at even beacon counts 10 and 16).

From beacon counts 19 to 20, the TIM transmission sequence 300 may undergo a second transition 345, where the TIM transmission sequence 300 switches from the second state 340 to a third state 350. The third state 350 can, for example, correspond to a DTIM interval of 6. In other words, the third state 350 can be associated with an operating mode where DTIMs 325 are transmitted every sixth beacon count.

In some examples, the second transition 345 may be triggered by a traffic condition at an AP 105. For instance, an AP 105 may have a low amount of traffic (e.g., an amount of traffic below a predetermined threshold for a period of time, a lack of traffic, or a lack of traffic for a predetermined amount of time, etc.) buffered for broadcast and/or multicast transmission to stations 115 being served by the AP 105. Upon determining a low amount of traffic (or absence of traffic for period of time), the second transition 345 can be associated with another increase in DTIM period. The new DTIM period associated with the third state 350 may be a pre-assigned maximum value associated with conditions relating to the first transition 335 (e.g., MaxDTIM), or the new DTIM period may be a calculated value based on such parameters as an amount of buffered data, data rates, types of stations 115 served by an access point, power conditions of stations 115 served by the AP 105, or the like.

From beacon counts 31 to 32, the TIM transmission sequence 300 may undergo a third transition 355, where the TIM transmission sequence 300 switches from the third state 350 back to the first state 330 (e.g., 330-b), corresponding to a DTIM period of 2. The third transition 355 may be triggered, for example, when the AP 105 has received buffered traffic to be sent to one or more stations 115 that are being served by the AP 105. In various examples, the receiving of traffic for broadcast and/or multicast transmission may have occurred at any point since the previous DTIM 325 transmission (e.g., any time between beacon counts 25 and 31), or any other suitable time to trigger such a transition. Therefore a transmission sequence may return to an initial state having a shorter DTIM interval, which may, in some examples, reduce latency associated with subsequent broadcast and/or multicast transmissions.

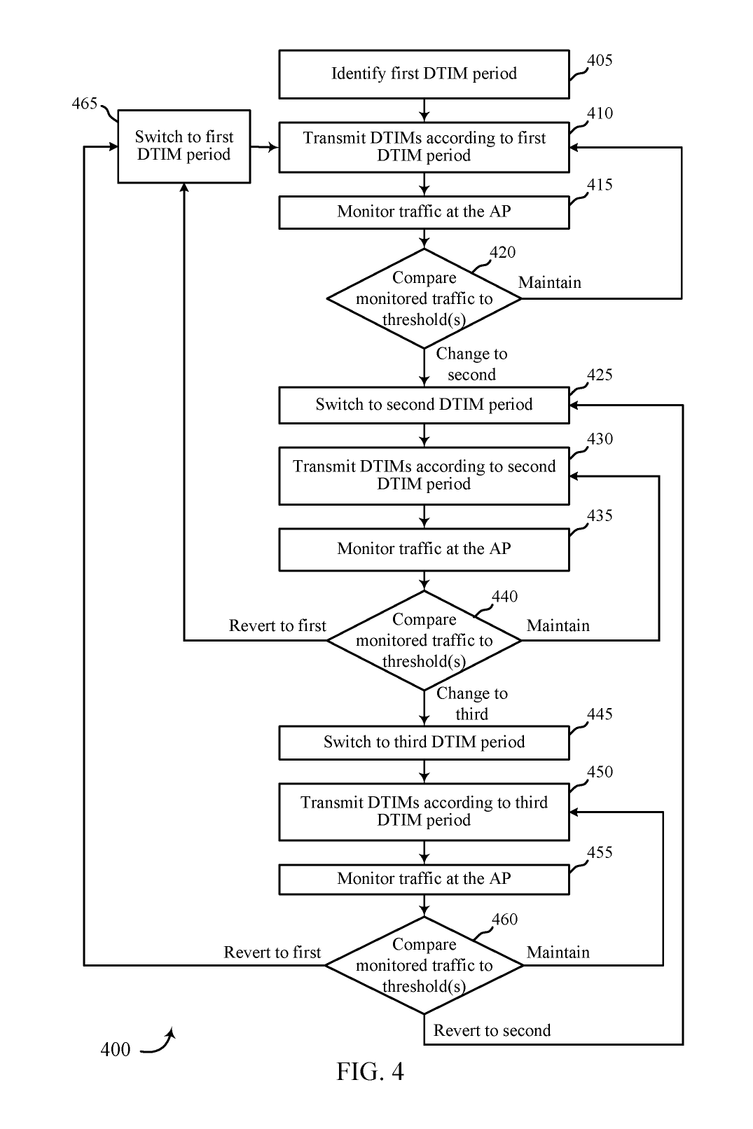

FIG. 4 illustrates a process flow 400 for providing dynamic DTIM implementations at an access point, in accordance with aspects of the present disclosure. The process flow 400 may be followed, for example, by an AP 105 as described with reference to FIG. 1.

At step 405 of the process flow 400, an AP 105 may identify a first DTIM period. In some examples the first DTIM period may be a defined value at the AP 105, such as a default DTIM period, an initialization DTIM period, or a user-defined DTIM period. In some examples the first DTIM period may be assigned by some other device in an associated wireless communication system, such as a central network administrator. In some examples the first DTIM period may be a period that supports legacy devices such as a minimum DTIM period, (e.g. MinDTIM), and may be associated with relatively frequent DTIM transmissions. In some examples, the first DTIM period may be associated, for example, with the first state 330 described with reference to FIG. 3, having a DTIM interval of 2. After identifying the first DTIM period, the method may proceed to step 410.

At step 410 of the process flow 400, the AP 105 may transmit one or more DTIMs according to a first DTIM period. In various examples, the DTIM may form at least a portion of a beacon frame transmission from the AP 105. As previously described with reference to FIG. 3, a DTIM may be transmitted at certain intervals, such as an integer number of beacon transmissions. For example, with reference to the first state 330, transmitting DTIMs according to the first DTIM period may correspond to transmitting a DTIM every other beacon transmission.

During step 410, the AP 105 may additionally transmit TIM IEs in beacon intervals not associated with DTIM transmissions, such as TIMs 320 described with reference to FIG. 3. Furthermore, the AP 105 may include information associated with the DTIM intervals in various beacon transmissions, such as in TIMs 320. For example, the AP 105 may include an indication of the first DTIM period in a DTIM period field 220 as described with reference to FIG. 2. The AP 105 may also decrement the value of DTIM count upon each beacon transmission, and include the decremented DTIM count in the TIMs 320, such as in a DTIM count field 215 described with reference to FIG. 2. While the AP 105 is transmitting one or more DTIMs according to the first DTIM period, or in some examples after completing the DTIM transmission, the method may proceed to step 415.

At step 415, the process flow 400 may include monitoring traffic at the AP 105. For example, the AP 105 may monitor incoming traffic from another part of the wireless communication system, such as a core network or a distribution system, where such traffic may include data that is to be buffered for broadcast and/or multicast transmission by the AP 105. In various examples the buffered traffic may be intended to be received by one or more stations 115 that are being served by the access point.

Although steps 410 and 415 are shown as sequential steps, steps 410 and 415 may occur at an AP 105 concurrently, or in another order. For example, the AP 105 may continually monitor traffic at the AP 105 while transmitting DTIMs according to the first DTIM period. In some examples, the AP 105 may monitor traffic at a monitoring interval, such as a time interval or an interval associated with an integer number of DTIMs. After the AP 105 has monitored traffic at the AP 105, the method may proceed to step 420.

At step 420, the process flow 400 may include comparing the monitored traffic to one or more thresholds. In various examples the threshold may be a particular amount of data, or a combination of an amount of data for an amount of time. The threshold may be associated with, for instance, a determination of whether the monitored traffic corresponds to a small amount of buffered data, or a detection of an absence of buffered data for broadcast and/or multicast transmission. According to aspects of the present disclosure, a determination that monitored traffic is below a threshold may, for example indicate that devices of the associated wireless communication system could operate more efficiently with a different DTIM period.

For example, by transmitting DTIMs from an AP 105 according to a longer DTIM period, stations 115 that support dynamic DTIM implementations may employ longer sleep durations, and therefore reduce power consumption in comparison to a listening interval according to the first DTIM period. Setting a longer DTIM period may be appropriate in examples where an AP 105 identifies a small amount of buffered data, or an absence of broadcast and/or multicast data, where the longer period would not adversely affect performance, such as unnecessarily increasing latency. Thus, upon comparing monitored traffic to one or more thresholds the method may identify conditions that warrant changing the DTIM period, and proceed to step 425. Under other conditions, such as a high amount of buffered traffic (e.g., buffered traffic above a threshold during a predetermined period of time, an median or average amount of buffered traffic above a threshold for a predetermined period of time, etc.), or a low amount of traffic for a time shorter than a predetermined time threshold, the method may return to step 410, and continue transmitting DTIMs according to the first DTIM period.

At step 425 the process flow 400 may include switching to a second DTIM period. Step 425 may be an example, for instance, of the second transition 345 described with reference to FIG. 3, where the DTIM period is changed to a second DTIM period, which may be an intermediate value (e.g., TransDTIM). Upon switching to the second DTIM period, the AP 105 may update a DTIM period value, which may be transmitted as part of a TIM IE. In some examples, this value can be updated in time to be included in the final DTIM transmission associated with DTIM transmissions according to the previous interval. In this way, stations 115 that are listening according to the previous DTIM period can wake up and identify the change in interval. In other examples, a DTIM period may be updated prior to the final DTIM transmission of the state, and included in TIM IEs. This may provide an indication to stations 115 that have not yet updated to a new listening interval, such as stations 115 that are establishing a communication link with the AP 105. In such examples, the DTIM count may continue decrementing with each beacon transmission without updating. In other examples, a change of the DTIM period value to the second DTIM period may occur at any suitable point of a TIM transmission stream. The AP 105 may also update a DTIM count value, such as an initial value of a DTIM count value, which may also be a portion of a TIM IE transmitted by the access point as part of a beacon frame.

At step 430 the process flow 400 may include transmitting DTIMs according to the second DTIM period. For example, with reference to the second state 340, transmitting DTIMs according to the second DTIM period may correspond to transmitting a DTIM every fourth beacon transmission. During step 430, the AP 105 may continue to transmit TIM IEs in beacon intervals not associated with DTIM transmissions, such as TIMs 320 described with reference to FIG. 3. Furthermore, the AP 105 may continue to include information associated with the DTIM intervals in various beacon transmissions, such as in TIMs 320. For example, the AP 105 may include an indication of the second DTIM period in a DTIM period field 220 as described with reference to FIG. 2. The AP 105 may also decrement the value of DTIM count upon each beacon transmission, and include the decremented DTIM count in the TIMs 320, such as in a DTIM count field 215 described with reference to FIG. 2. While the AP 105 is transmitting one or more DTIMs according to the second DTIM period, or in some examples after completing the DTIM transmission, the method may proceed to step 435.

At step 435 the process flow 400 may include monitoring traffic at the access point. Similarly to step 415, at step 435 the AP 105 may continue to monitor incoming traffic from another part of the wireless communication system, such as a core network or a distribution system, where such traffic may include data that is to be buffered for broadcast and/or multicast transmission by the AP 105. In various examples the buffered traffic may be intended to be received by one or more stations 115 that are being served by the access point.

Although steps 430 and 435 are shown as sequential steps, steps 430 and 435 may occur at an AP 105 concurrently, or in another order. For example, the AP 105 may continually monitor traffic at the AP 105 while transmitting DTIMs according to the second DTIM period. In some examples, the AP 105 may monitor traffic at a monitoring interval, such as a time interval or an interval associated with an integer number of DTIMs. After the AP 105 has monitored traffic at the AP 105, the method may proceed to step 440.

At step 440 the process flow 400 may include comparing the monitored traffic to one or more thresholds. In various examples the threshold may again be a particular amount of data, or a combination of an amount of data for an amount of time. The threshold may be associated with, for instance, a determination of whether the monitored traffic corresponds to a small amount of buffered data, or an absence of buffered data for broadcast and/or multicast transmission. According to aspects of the present disclosure, a determination that monitored traffic is above a threshold or below a threshold may, for example indicate that devices of the associated wireless communication system could operate more efficiently with a different DTIM period. Thus, in some examples, the comparison may indicate that the AP 105 should switch to a new DTIM period (e.g., a third DTIM period), and the process flow 400 may proceed to step 445. In some examples the comparison may indicate that the AP 105 should revert to the first DTIM period, such as detecting a presence of broadcast or multicast traffic, and the process flow 400 may proceed to step 465. In some examples the comparison may indicate that the DTIM period need not be changed, and the process flow may return to step 430.

For example, by transmitting DTIMs from an AP 105 according to an even longer DTIM period, stations 115 that support dynamic DTIM implementations may employ even longer sleep durations, and further reduce power consumption in comparison to a listening interval according to the second DTIM period. Setting a longer DTIM period may be appropriate in examples where an AP 105 identifies a small amount of buffered broadcast and/or multicast traffic, or an absence of broadcast and/or multicast traffic, where the longer period would not adversely affect performance, such as increasing latency. Thus, upon comparing monitored traffic to one or more thresholds the method may identify conditions that warrant changing the DTIM period, and proceed to step 445. Under other conditions, such as a high amount of buffered traffic at the AP 105 (which may be a presence of buffered traffic for broadcast and/or multicast transmission, or a presence of an amount of buffered traffic above a threshold), the method may identify conditions that warrant reverting to the first DTIM period in order to reduce latency, and proceed to step 465.

At step 445 the process flow 400 may include switching to a third DTIM period. Step 425 may be an example of the second transition 345 described with reference to FIG. 3, where the DTIM period is changed to a maximum value (e.g., MaxDTIM). Upon switching to the third DTIM period, the AP 105 may again update a DTIM period value, which may be transmitted as part of a TIM IE. In some examples, this value can be updated in time to be included in the final DTIM transmission associated with DTIM transmissions according to the previous interval. In this way, stations 115 that are listening according to the previous DTIM period can wake up and identify the change in interval. In other examples, a DTIM period may be updated prior to the final DTIM transmission of the state, and included in TIM IEs. This may provide an indication to stations 115 that have not yet updated to a new listening interval, such as stations 115 that are establishing a communication link with the AP 105. In such examples, the DTIM count may continue decrementing with each beacon transmission without updating. In other examples, a change of the DTIM period value to the third DTIM period may occur at any suitable point of a TIM transmission stream. The AP 105 may also update a DTIM count value, such as an initial value of a DTIM count value, which may also be a portion of a TIM IE transmitted by the access point as part of a beacon frame.

At step 450 the process flow 400 may include transmitting DTIMs according to the third DTIM period. For example, with reference to the third state 350, transmitting DTIMs according to the third DTIM period may correspond to transmitting a DTIM every sixth beacon transmission. During step 450, the AP 105 may continue to transmit TIM IEs in beacon intervals not associated with DTIM transmissions, such as TIMs 320 described with reference to FIG. 3. Furthermore, the AP 105 may continue to include information associated with the DTIM intervals in various beacon transmissions, such as in TIMs 320. For example, the AP 105 may include an indication of the third DTIM period in a DTIM period field 220 as described with reference to FIG. 2. The AP 105 may also decrement the value of DTIM count upon each beacon transmission, and include the decremented DTIM count in the TIMs 320, such as in a DTIM count field 215 described with reference to FIG. 2. While the AP 105 is transmitting one or more DTIMs according to the third DTIM period, or in some examples after completing the DTIM transmission, the method may proceed to step 455.

At step 455 the process flow 400 may include monitoring traffic at the AP 105. Similarly to steps 415 and 435, at step 455 the AP 105 may continue to monitor incoming traffic from another part of the wireless communication system, such as a core network or a distribution system, where such traffic may include data that is to be buffered for broadcast and/or multicast transmission by the AP 105. In various examples the buffered traffic may be intended to be received by one or more stations 115 that are being served by the access point.

Although steps 450 and 455 are shown as sequential steps, steps 450 and 455 may occur at an AP 105 concurrently, or in another order. For example, the AP 105 may continually monitor traffic at the AP 105 while transmitting DTIMs according to the third DTIM period. In some examples, the AP 105 may monitor traffic at a monitoring interval, such as a time interval or an interval associated with an integer number of DTIMs. After the AP 105 has monitored traffic at the AP 105, the method may proceed to step 440.

At step 460 the process flow 400 may include comparing the monitored traffic to one or more thresholds. In various examples the threshold may again be a particular amount of data, or a combination of an amount of data for an amount of time. The threshold may be associated with, for instance, a determination of whether the monitored traffic corresponds to a small amount of buffered data, or an absence of buffered data for broadcast and/or multicast transmission. According to aspects of the present disclosure, a determination that monitored traffic is above a threshold or below a threshold may, for example indicate that devices of the associated wireless communication system could operate more efficiently with a different DTIM period.

In some examples, such as conditions where there is a high amount of buffered traffic at the AP 105 (which may be a detection of the presence of buffered traffic for broadcast and/or multicast transmission), the comparison may indicate that the AP 105 may revert to the first DTIM period in order to reduce latency, and the process flow 400 may proceed to step 465. In some examples, such as a moderate amount of buffered broadcast and/or multicast traffic at the AP 105, the comparison may indicate that the AP 105 may revert to the second DTIM period, and the process flow 400 may return to step 425. In other examples, as soon as broadcast and/or multicast traffic is buffered at an AP 105, the method may proceed to step 465, such that no conditions would cause the method to proceed to step 425 and revert to the second DTIM period from the third DTIM period. In some examples, such as an ongoing lack of buffered broadcast and/or multicast traffic at the AP 105, the comparison may indicate that the DTIM period need not be changed, and the process flow may return to step 450.

At step 465 the process flow 400 may include switching back to the first DTIM period. Step 425 may be an example of third transition 355 described with reference to FIG. 3. Therefore, upon switching back to the first DTIM period, the process flow 400 may return to step 410, and continue transmitting DTIMs according to the first DTIM period. In some examples, reverting to the first DTIM period may reduce latency associated with broadcast and/or multicast transmissions from the AP 105 to stations 115 being served by the AP 105

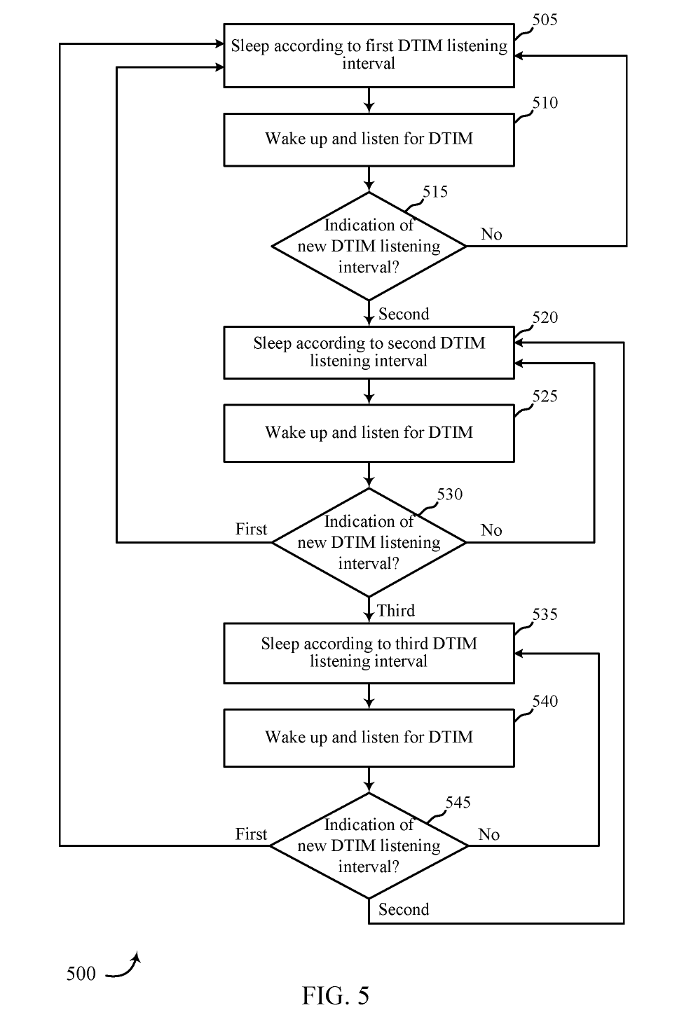

FIG. 5 illustrates a process flow 500 for providing dynamic DTIM implementations at a station, in accordance with aspects of the present disclosure. The process flow 500 may be performed, for example, by the stations 115 described with reference to FIG. 1.

At step 505 of the process flow 500, a station 115 may sleep according to a first DTIM listening interval (including listening for transmitted DTIMs according to the first DTIM listening interval). During a sleep mode, the station 115 may operate according to a power management mode (e.g., a power-save or reduced power mode) in which various components of the station 115 are powered off or operated in a low-power mode in order to reduce power consumption at the station. This may include, for example, a low-power or disabled mode of a receiver, a demodulator, and/or a DSP or portions of a DSP associated with listening to DTIMs. In some examples this may include a reduced-power operation of components that listen to and/or decode beacon signals. Although aspects of the power management mode may be dictated by the indication to sleep according to the first DTIM interval, in some examples aspects of the power management mode may be superseded by other operations at the station 115. For example, a power management mode of a station 115 that is configured to sleep according to a first DTIM interval may still allow a receiver or a demultiplexer to be operated at a higher power condition, for example to listen to unicast traffic from an AP 105.

At step 510 of the process flow 500, a station 115 may wake up and listen for DTIM transmissions. Step 510 may include, for instance, powering up a receiver at the station 115, and processing received signals to identify and interpret a DTIM. In some examples, this may include the station 115 listening for beacon signals transmitted by the AP 105. In some examples step 510 may be triggered at the station 115 by the expiration of a timer that had been initialized according to the first DTIM listening interval. In some examples, the timer may be somewhat shorter than the DTIM listening interval, so that components associated with listening to DTIMs have adequate time to power-up or otherwise transition from a sleep mode to an awake mode. When a received DTIM indicates that the AP 105 has buffered broadcast and/or multicast traffic for the station 115, the station 115 may take steps to receive the broadcast and/or multicast transmissions. For example, the station 115 may continue to operate a receiver and a demodulator in a powered-up condition in order to receive broadcast and/or multicast traffic. In various examples, steps 505 and 510 may, in combination, refer to a process listening to DTIMs according to a first DTIM listening interval.

At step 515 of the process flow 500, a station 115 may receive an indication of a new DTIM listening interval. For example, an AP 105 may have identified a lack of broadcast and/or multicast traffic for one or more stations 115 served by the AP 105, and broadcast an indication that a longer DTIM period may be employed by the AP 105. Thus, by receiving the indication of a different DTIM period employed by an AP 105, the station 115 may interpret an indication of a new DTIM listening interval for the station 115. In various examples, the station 115 may identify that a DTIM period field of a TIM information element has been updated, or may identify that the DTIM count field in a TIM information element following a DTIM has a value that indicates a different DTIM period. In other examples the station 115 may otherwise receive the indication of a new DTIM listening interval, such as through an information element other than a TIM information element. If an indication of a new DTIM listening interval is received (e.g., an indication of a second DTIM listening interval), the process flow 500 may proceed to step 520.

In some examples, no indication of a new DTIM listening interval may have been received. The lack of indication of a new DTIM listening interval may include, for example, a consistent DTIM period value being transmitted by an AP 105 serving the station 115. In some examples, a lack of such an indication may be the result of a station 115, which supports dynamic DTIM implementations, ignoring such an indication. When no indication of a new DTIM listening interval is received, station 115 may continue listening according to the first interval in steps 505 and 510.

At step 520 of the process flow 500, upon receiving the indication of a second DTIM listening interval, a station 115 may sleep according to a second DTIM listening interval. During the sleep mode, the station 115 may operate according to a power management mode (e.g., a power-save or reduced power mode) in which various components of the station 115 are operated in a low-power mode in order to reduce power consumption at the station, similar to the operation in step 505. However, by operating according to a different sleep interval, various components may operate in a powered-down or disabled mode for a shorter or longer period.

For example, the station 115 may receive an indication that an AP 105 will be operating with a longer DTIM period, and the station may respond by powering down components associated with receiving DTIMs for a longer duration. In such examples, the longer duration in a sleep mode may reduce the duty cycle (e.g., the ratio of powered-up time over total time) of those components, and therefore reduce power consumption associated with listening for DTIMs.

In some examples, a longer duration may permit a power management mode to power down components that were previously unable to be powered down while sleeping according to the first DTIM listening interval. For example, the duration of a sleep mode associated with the first DTIM listening interval may have been too short to allow some components to power down and power back up. In examples where the second DTIM listening interval is longer than the first DTIM listening interval, sleeping according to the second DTIM listening interval may provide a long enough sleep duration that those components may be powered down, and therefore further reduce power consumption at the station 115.

At step 525 of the process flow 500, a station 115 may again wake up and listen for DTIM transmissions. Similar to step 510, step 525 may include, for instance, powering up a receiver at the station 115, and processing received signals to identify and interpret a DTIM. In some examples step 525 may be triggered at the station 115 by the expiration of a timer that had been initialized according to the second DTIM listening interval. When a received DTIM indicates that the AP 105 has buffered broadcast and/or multicast traffic for the station 115, the station 115 may take steps to receive the broadcast and/or multicast transmissions. For example, the station 115 may continue to operate a receiver and a demodulator in a powered-up condition in order to receive broadcast and/or multicast traffic. In various examples, steps 520 and 525 may, in combination, refer to a process listening to DTIMs according to a second DTIM listening interval.

At step 530 of the process flow 500, a station 115 may receive an indication of a new DTIM listening interval. For example, an AP 105 may have identified a continuing lack of broadcast and/or multicast traffic for one or more stations 115 served by the AP 105, and broadcast an indication that an even longer DTIM period may be employed by the AP 105. Thus, by receiving the indication of a different DTIM period employed by an AP 105, the station 115 may interpret an indication of a new DTIM listening interval for the station 115. If an indication of a new DTIM listening interval is received (e.g., an indication of a third DTIM listening interval), the process flow 500 may proceed to step 535.

In some examples the station 115 may receive an indication that the station should revert to the first DTIM listening interval, which may be shorter than the first DTIM listening interval. Such an indication may be received when an AP 105 has buffered broadcast and/or multicast traffic for stations 115 served by the AP 105, and the AP 105 reverts to a shorter DTIM period in order to reduce latency associated with broadcast and/or multicast communications. In some examples, no indication of a new DTIM listening interval may have been received. When no indication of a new DTIM listening interval is received, station 115 may continue listening according to the second DTIM listening interval in steps 520 and 525.

At step 535 of the process flow 500, upon receiving the indication of a third DTIM listening interval, a station 115 may sleep according to a third DTIM listening interval. During the sleep mode, the station 115 may operate according to a power management mode (e.g., a power-save or reduced power mode) in which various components of the station 115 are operated in a low-power mode in order to reduce power consumption at the station, similar to the operations in step 505 or 520. However, by operating according to a different sleep interval, and listening for DTIMs according to the third DTIM listening interval, various components may operate in a powered-down or disabled mode for a shorter or longer period.

For example, the station 115 may receive an indication that an AP 105 will be operating with an even longer DTIM period, and the station may respond by powering down components associated with receiving DTIMs for an even longer duration. In such examples, the longer duration in a sleep mode may further reduce the duty cycle (e.g., the ratio of powered-up time over total time) of those components, and therefore reduce power consumption associated with listening for DTIMs.

In some examples, a longer duration may permit a power management component of the station, operating according to a power management mode, may power down components that were previously unable to be powered down while sleeping according to the first DTIM listening interval. For example, the duration of a sleep mode associated with the first DTIM listening interval may have been too short to allow some components to power down and power back up. In examples where the third DTIM listening interval is longer than the first or second DTIM listening interval, sleeping according to the third DTIM listening interval may provide a long enough sleep duration that those components may be powered down, and therefore further reduce power consumption at the station 115.

At step 540 of the process flow 500, a station 115 may again wake up and listen for DTIM transmissions. Similar to steps 510 or 525, step 540 may include, for instance, powering up a receiver at the station 115, and processing received signals to identify and interpret a DTIM. In some examples step 540 may be triggered at the station 115 by the expiration of a timer that had been initialized according to the second DTIM listening interval. When a received DTIM indicates that the AP 105 has buffered broadcast and/or multicast traffic for the station 115, the station 115 may take steps to receive the broadcast and/or multicast transmissions. For example, the station 115 may continue to operate a receiver and a demodulator in a powered-up condition in order to receive broadcast and/or multicast traffic. In various examples, steps 535 and 540 may, in combination, refer to a process listening to DTIMs according to a third DTIM listening interval.

At step 545 of the process flow 500, a station 115 may receive an indication of a new DTIM listening interval. For example, an AP 105 may have identified a presence of traffic buffered for broadcast and/or multicast transmission to stations 115 served by the AP 105, and the AP 105 may revert to a shorter DTIM period in order to reduce latency associated with broadcast and/or multicast communications. In various examples, an AP 105 may revert to either the first DTIM period or the second DTIM period. Thus, the station 115 may receive an indication to revert to the first DTIM listening interval and the process flow 500 may return to step 505, or the station may receive an indication to revert to the second DTIM listening interval and the process flow 500 may return to step 520. In some examples, no indication of a new DTIM listening interval may have been received. When no indication of a new DTIM listening interval is received, station 115 may continue listening according to the third DTIM listening interval in steps 535 and 540.

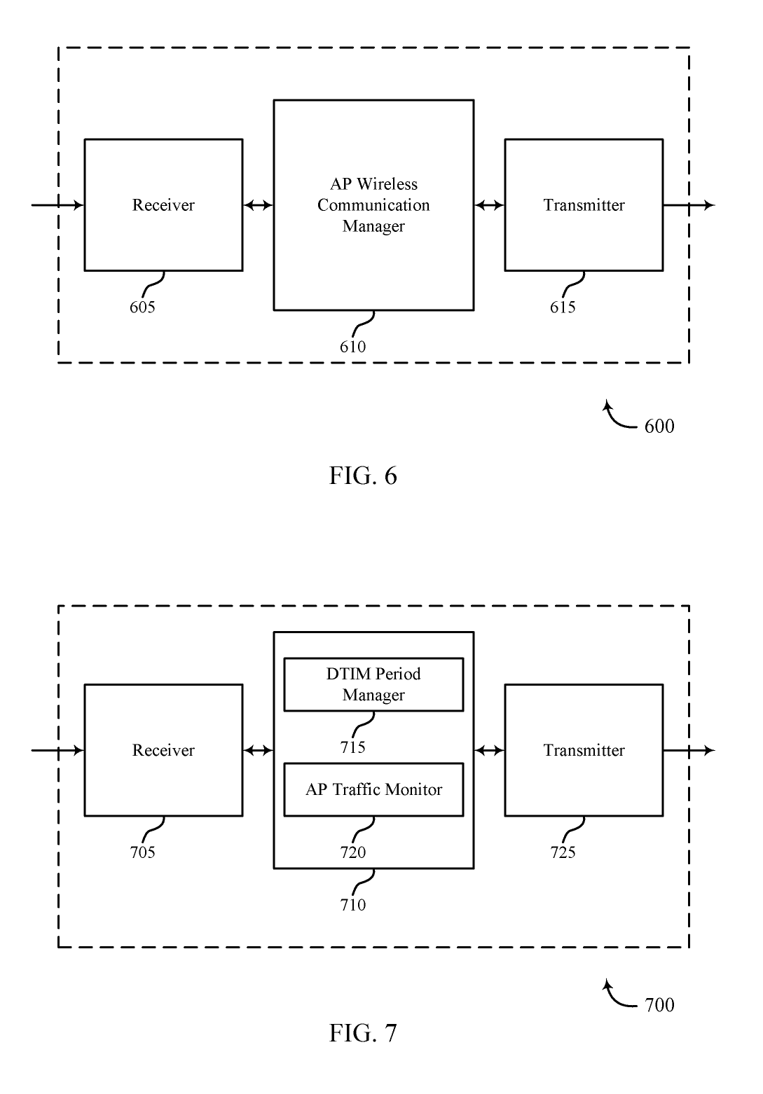

FIG. 6 shows a block diagram of a wireless communication device 600 that supports dynamic DTIM implementations in accordance with various aspects of the present disclosure. Wireless communication device 600 may be an example of aspects of an AP 105 as described with reference to FIGS. 1 and 2. Wireless communication device 600 may include a receiver 605, an AP wireless communication manager 610 and a transmitter 615. Each of these components may be in communication with each other.

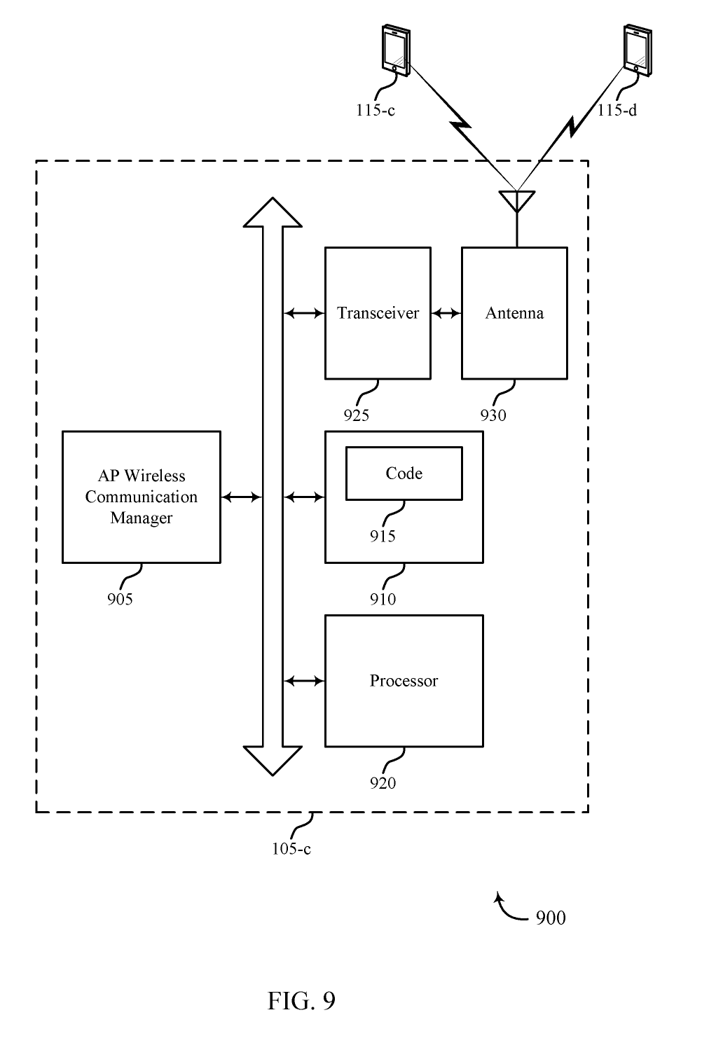

The receiver 605 may receive information such as packets, user data, or control information associated with various information channels (e.g., control channels, data channels, and information related to dynamic DTIM implementations, etc.). For example, the receiver may receive traffic to be buffered by the wireless communication device 600 for broadcast and/or multicast transmission to one or more stations served by the wireless communication device 600. Information may be passed on to other components of the device. The receiver 605 may be an example of aspects of the transceiver 925 described with reference to FIG. 9.

The AP wireless communication manager 610 may identify a first DTIM period, monitor traffic for broadcast and/or multicast transmission, and switch to different DTIM periods based on comparisons of the monitored traffic to various traffic threshold. For example, the AP wireless communication manager 610 may be operable to perform the steps 405 through 465 of process flow 400 as described with reference to FIG. 4. The AP wireless communication manager 610 may also be an example of aspects of the AP wireless communication manager 905 described with reference to FIG. 9.

The transmitter 615 may transmit signals received from other components of wireless communication device 600. For example, the transmitter 615 may be configured to transmit traffic to various stations served by the wireless communication device 600, including broadcast and/or multicast transmissions. The transmitter 615 may also be configured to transmit DTIMs, which may be a form of TIM information elements, and may be transmitted as part of a beacon transmission. In some examples, the transmitter 615 may be collocated with a receiver in a transceiver module. For example, the transmitter 615 may be an example of aspects of the transceiver 925 described with reference to FIG. 9. The transmitter 615 may include a single antenna, or it may include more than one antenna.

FIG. 7 shows a block diagram of a wireless communication device 700 that supports dynamic DTIM implementations in accordance with various aspects of the present disclosure. Wireless communication device 700 may be an example of aspects of a wireless communication device 600 or a AP 105 described with reference to FIGS. 1, 2 and 6. Wireless communication device 700 may include a receiver 705, an AP wireless communication manager 710 and a transmitter 725. Each of these components may be in communication with each other.

The receiver 705 may receive information which may be passed on to other components of the device. The receiver 705 may also perform the functions described with reference to the receiver 605 of FIG. 6. The receiver 705 may be an example of aspects of the transceiver 925 described with reference to FIG. 9.

The AP wireless communication manager 710 may be an example of aspects of AP wireless communication manager 610 described with reference to FIG. 6. The AP wireless communication manager 710 may include DTIM period manager 715 and AP traffic monitor 720. The AP wireless communication manager 710 may be an example of aspects of the AP wireless communication manager 905 described with reference to FIG. 9.

The DTIM period manager 715 may manage DTIM periods, and the transition between operating states associated with various DTIM periods. The DTIM period manager 715 may associate amounts of broadcast and/or multicast traffic with a DTIM period, and may generate values, such as a DTIM period or a DTIM count that may be transmitted as part of a TIM information element. In order to support legacy stations, or stations that are otherwise not configured for dynamic DTIM implementations, the DTIM period manager may configure the wireless communication device 700 to have a minimum DTIM period, and have other DTIM periods be integer multiples of the minimum DTIM period.

The AP traffic monitor 720 may monitor traffic for broadcast and/or multicast transmission to various stations served by the wireless communication device 700. For example, the AP traffic monitor may identify a presence or absence of the traffic to be transmitted by broadcast and/or multicast transmission. The AP traffic monitor 720 may also compare the monitored traffic, or a value representing the traffic, to various traffic thresholds during various time periods.

The transmitter 725 may transmit signals received from other components of wireless communication device 700. In some examples, the transmitter 725 may be collocated with a receiver in a transceiver module. For example, the transmitter 725 may be an example of aspects of the transceiver 925 described with reference to FIG. 9. The transmitter 725 may utilize a single antenna, or it may utilize more than one antenna.

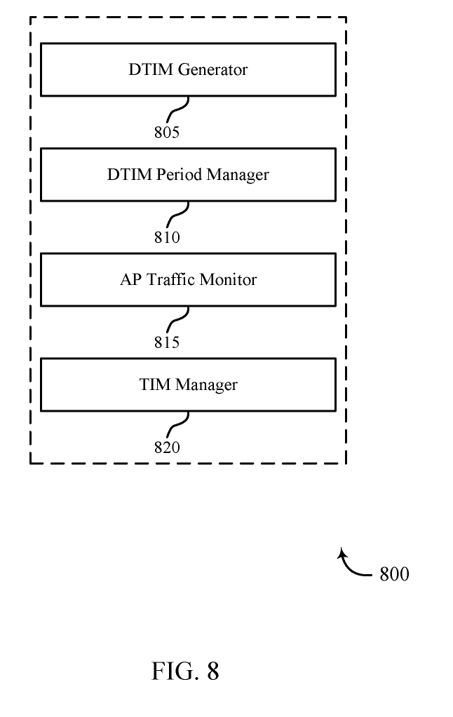

FIG. 8 shows a block diagram of a AP wireless communication manager 800 which may be an example of the corresponding component of wireless communication device 600 or wireless communication device 700. That is, AP wireless communication manager 800 may be an example of aspects of AP wireless communication manager 610 or AP wireless communication manager 710 described with reference to FIGS. 6 and 7. The AP wireless communication manager 800 may also be an example of aspects of the AP wireless communication manager 905 described with reference to FIG. 9.

The AP wireless communication manager 800 may include a DTIM generator 805, a DTIM period manager 810, an AP traffic monitor 815, and a TIM manager 820. Each of these modules may communicate, directly or indirectly, with one another (e.g., via one or more buses).

The DTIM generator 805 may generate DTIMs. Generating DTIMs may, for example, include various aspects of preparing an indication to stations being served by an AP that broadcast or multicast traffic is buffered for transmission. In some examples DTIMs may be generated according to the TIM information element frame format 200 as described with reference to FIG. 2. For example, generating a DTIM may include updating data fields of a TIM information element such as any one or more of a length field 210, a DTIM count field 215, a DTIM period field 220, a bitmap control field 225, or a partial virtual bitmap field 230. In some examples DTIMs may be generated, and prepared for transmission by an AP when a DTIM count equals zero. In some examples DTIMs may be prepared for broadcast in a portion of a beacon transmission by an AP.

The DTIM period manager 810 may manage DTIM periods, and the transition between operating states associated with various DTIM periods. The DTIM period manager 810 may associate amounts of broadcast and/or multicast traffic with a DTIM period, and may generate values, such as a DTIM period or a DTIM count that may be transmitted as part of a TIM information element. In order to support legacy stations, or stations that are otherwise not configured for dynamic DTIM implementations, the DTIM period manager may configure the wireless communication device 700 to have a minimum DTIM period, and have other DTIM periods be integer multiples of the minimum DTIM period.

The AP traffic monitor 815 may monitor traffic for broadcast and/or multicast transmission to various stations served by a wireless communication device. For example, the AP traffic monitor may identify a presence or absence of the traffic to be transmitted by broadcast and/or multicast transmission. The AP traffic monitor 815 may also compare the monitored traffic, or a value representing the traffic, to various traffic thresholds during various time periods.

The TIM manager 820 may manage the transmission of TIM information elements by a wireless communication device. For example, the TIM manager 820 may associate information into a TIM IE frame format, such as TIM information element frame format 200 described with reference to FIG. 2. In some examples, when a DTIM count value associated with TIM transmissions reaches 0, the TIM manager 820 may be configured to associate a TIM transmission as a DTIM transmission. In some examples the DTIM transmission may be coordinated with the DTIM generator 805 and a transmitter to transmit a plurality of DTIMs in beacon frames according to a DTIM period. In some examples, and in coordination with the DTIM period manager 810 and a transmitter, the TIM manager may transmit an updated DTIM period value when the DTIM count is 0.

The components of wireless communication device 600, wireless communication device 700, AP wireless communication manager 610, AP wireless communication manager 710, AP wireless communication manager 800 may, individually or collectively, be implemented with at least one application-specific integrated circuit (ASIC) adapted to perform some or all of the applicable features in hardware. Alternatively, the features may be performed by one or more other processing units (or cores), on at least one integrated circuit (IC). In other examples, other types of integrated circuits may be used (e.g., Structured/Platform ASICs, a FPGA, or another semi-custom IC), which may be programmed in any manner known in the art. The features may also be implemented, in whole or in part, with instructions embodied in a memory, formatted to be executed by one or more general or application-specific processors.

FIG. 9 shows a diagram of a system 900 including a device that supports dynamic DTIM implementations in accordance with various aspects of the present disclosure. For example, system 900 may include AP 105-c, which may be an example of a wireless communication device 600, a wireless communication device 700, or an access point (AP) 105 as described with reference to FIGS. 1, 2 and 6 through 8. AP 105-c may include memory 910, a processor 920, a transceiver 925, an antenna 930, and an AP wireless communication manager 905. Each of these modules may communicate, directly or indirectly, with one another (e.g., via one or more buses). The AP wireless communication manager 905 may be an example of an AP wireless communication manager as described with reference to FIGS. 6 through 8.

The memory 910 may include random access memory (RAM) and read only memory (ROM). The memory 910 may store computer-readable, computer-executable software or firmware code 915 including instructions that, when executed by the processor, cause the AP 105-c to perform various functions described herein (e.g., dynamic DTIM implementations, etc.). In some cases, the code 915 may not be directly executable by the processor but may cause a computer (e.g., when compiled and executed) to perform functions described herein. The processor 920 may include an intelligent hardware device, (e.g., a central processing unit (CPU), a microcontroller, an application-specific integrated circuit (ASIC), etc.)

The transceiver 925 may communicate bi-directionally, via one or more antennas, wired, or wireless links, with one or more networks, as described above. For example, the transceiver 925 may communicate bi-directionally with an AP 105 or a station 115. The transceiver 925 may also include a modem to modulate the packets and provide the modulated packets to the antennas for transmission, and to demodulate packets received from the antennas. In some cases, the wireless communication device may include a single antenna 930. However, in some cases the device may have more than one antenna 930, which may be capable of concurrently transmitting or receiving multiple wireless transmissions, or may be capable of various beamforming techniques.

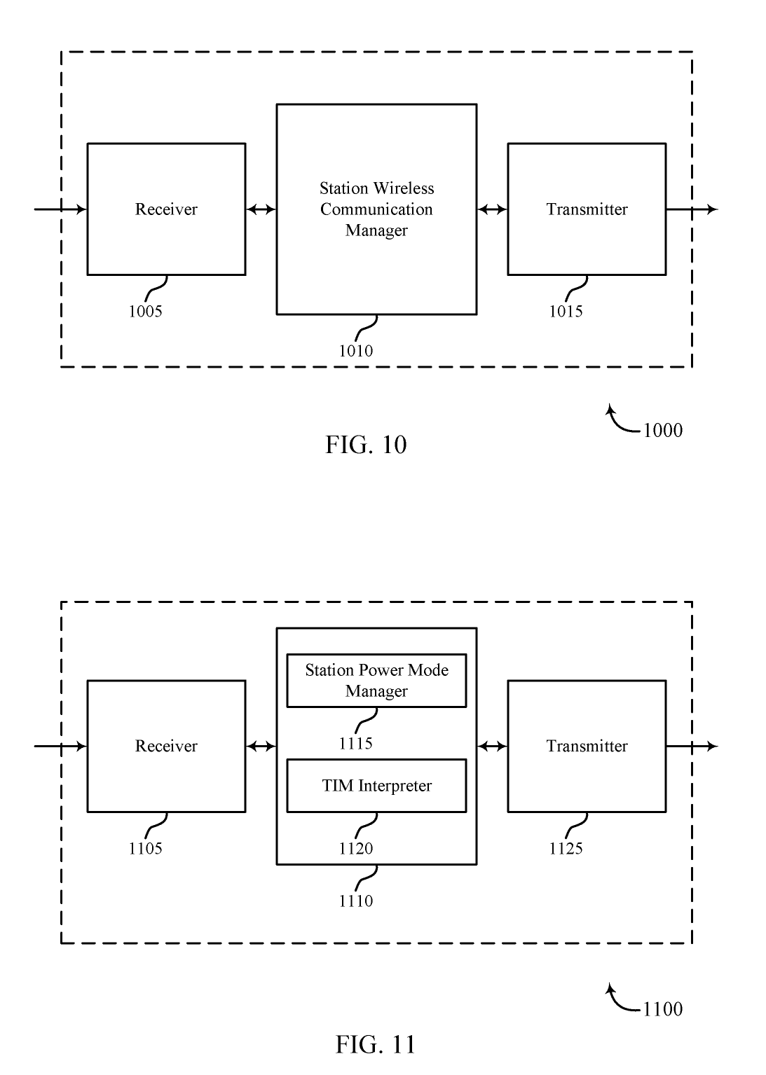

FIG. 10 shows a block diagram of a wireless communication device 1000 that supports dynamic DTIM implementations in accordance with various aspects of the present disclosure. Wireless communication device 1000 may be an example of aspects of a station 115 described with reference to FIG. 1. Wireless communication device 1000 may include a receiver 1005, a station wireless communication manager 1010 and a transmitter 1015. Each of these components may be in communication with each other.

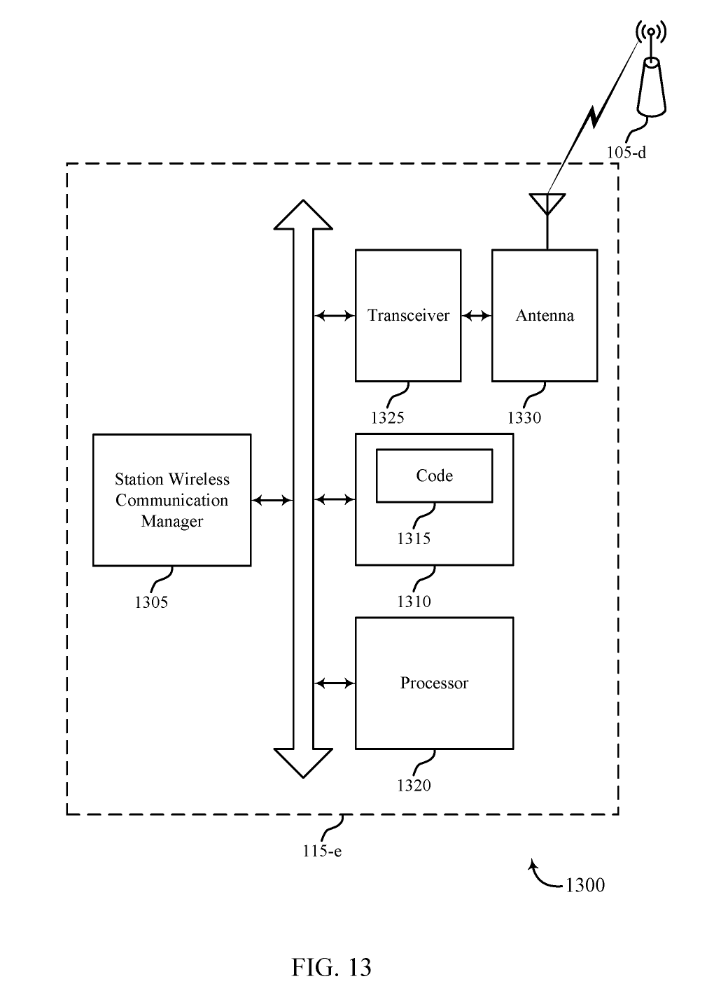

The receiver 1005 may receive information such as packets, user data, or control information associated with various information channels (e.g., control channels, data channels, and information related to dynamic DTIM implementations, etc.). For example, the receiver may receive DTIMs that may indicate whether an AP serving the wireless communication device 1000 has buffered traffic to be transmitted by broadcast and/or multicast transmission. Thus the receiver 1005 may be configured to receive TIM information elements, which may be received as a beacon signal from an AP. The receiver may also be configured to receive information from an AP, including the broadcast and/or multicast transmissions intended for the wireless communication device 1000. Information may be passed on to other components of the device. The receiver 1005 may be an example of aspects of the transceiver 1325 described with reference to FIG. 13.

The station wireless communication manager 1010 may manage various aspects of dynamic DTIM implementations. For example, the station wireless communication manager 1010 may control aspects of a power management mode (e.g., a power-save mode or a reduced power mode), including a sleep mode, an awake mode, or a wake-up configuration. The station wireless communication manager 1010 may also receive and interpret indications of a change in DTIM listening interval, which may be found, for example, in a DTIM period or a DTIM count data field of a TIM information element, where the TIM information element may be decoded by the station wireless communication manager 1010 from a portion of a beacon signal. The station wireless communication manager 1010 may also determine a new DTIM listening interval based on such indications. For example, the station wireless communication manager 1010 may be operable to perform the steps 505 through 545 of process flow 500 as described with reference to FIG. 5. The station wireless communication manager 1010 may also be an example of aspects of the station wireless communication manager 1305 described with reference to FIG. 13.

The transmitter 1015 may transmit signals received from other components of wireless communication device 1000. In some examples, the transmitter 1015 may be collocated with a receiver in a transceiver module. For example, the transmitter 1015 may be an example of aspects of the transceiver 1325 described with reference to FIG. 13. The transmitter 1015 may include a single antenna, or it may include more than one antenna.

FIG. 11 shows a block diagram of a wireless communication device 1100 that supports dynamic DTIM implementations in accordance with various aspects of the present disclosure. Wireless communication device 1100 may be an example of aspects of a wireless communication device 1000 or a station 115 described with reference to FIGS. 1, 2, and 10. Wireless communication device 1100 may include receiver 1105, station wireless communication manager 1110 and transmitter 1125. Each of these components may be in communication with each other.

The receiver 1105 may receive information which may be passed on to other components of the device. The receiver 1105 may also perform the functions described with reference to the receiver 1005 of FIG. 10. The receiver 1105 may be an example of aspects of the transceiver 1325 described with reference to FIG. 13.

The station wireless communication manager 1110 may be an example of aspects of the station wireless communication manager 1010 described with reference to FIG. 10. The station wireless communication manager 1110 may include station power mode manager 1115 and TIM interpreter 1120. The station wireless communication manager 1110 may be an example of aspects of the station wireless communication manager 1305 described with reference to FIG. 13.

The station power mode manager 1115 may control aspects of a power management mode (e.g., a power-save mode or a reduced power mode), including a sleep mode, an awake mode or a wake-up configuration. For example, the station power mode manager may manage aspects of a sleep mode and a listening mode associated with listening for DTIMs according to a DTIM listening interval. In various examples, the station power mode manager 1115 may operate or otherwise control various aspects of the wireless communication device to operate in a powered down mode or a powered up mode.

The TIM interpreter 1120 may interpret various TIM information elements, which in some examples may include an indication of various DTIM listening intervals. For example, the TIM interpreter 1120 may decode a TIM information element to interpret information in a DTIM period data field of a DTIM count data field of the TIM information element.

The transmitter 1125 may transmit signals received from other components of wireless communication device 1100. In some examples, the transmitter 1125 may be collocated with a receiver in a transceiver module. For example, the transmitter 1125 may be an example of aspects of the transceiver 1325 described with reference to FIG. 13. The transmitter 1125 may utilize a single antenna, or it may utilize more than one antenna.

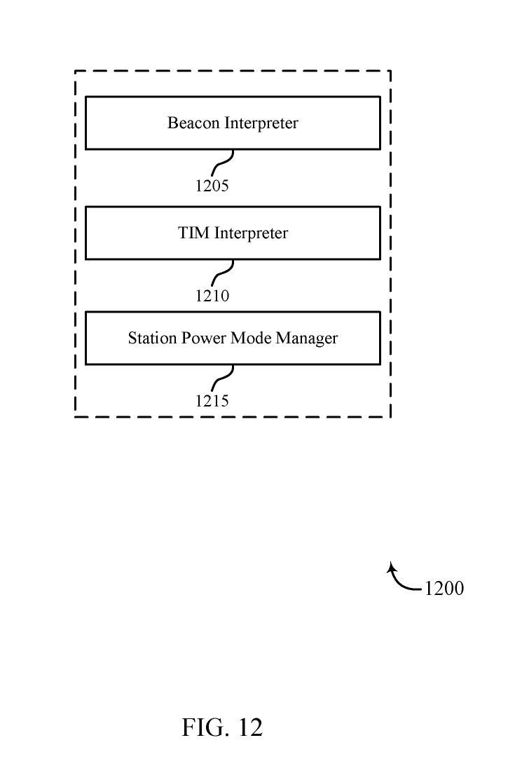

FIG. 12 shows a block diagram of a station wireless communication manager 1200 which may be an example of the corresponding component of wireless communication device 1000 or wireless communication device 1100. That is, station wireless communication manager 1200 may be an example of aspects of station wireless communication manager 1010 or station wireless communication manager 1110 described with reference to FIGS. 10 and 11. The station wireless communication manager 1200 may also be an example of aspects of the station wireless communication manager 1305 described with reference to FIG. 13.

The station wireless communication manager 1200 may include a beacon interpreter 1205, a TIM interpreter 1210 and a station power mode manager 1215. Each of these modules may communicate, directly or indirectly, with one another (e.g., via one or more buses).

The beacon interpreter 1205 may operate in coordination with a receiver to listen for beacon signals from an AP. In some examples the beacon interpreter 1205 may identify and/or extract a TIM information element from the beacon signal.

The TIM interpreter 1210 may interpret various TIM information elements, which in some examples may include an indication of various DTIM listening intervals. For example, the TIM interpreter 1210 may decode a TIM information element to interpret information in a DTIM period data field of a DTIM count data field of the TIM information element.

The station power mode manager 1215 may control aspects of a power management mode (e.g., a power-save mode or a reduced power mode), including a sleep mode, an awake mode or a wake-up configuration. For example, the station power mode manager may manage aspects of a sleep mode and a listening mode associated with listening to DTIMs according to a DTIM listening interval. In various examples, the station power mode manager 1215 may operate or otherwise control various aspects of the wireless communication device to operate in a powered down mode or a powered up mode.

The components of wireless communication device 1000, wireless communication device 1100, station wireless communication manager 1010, station wireless communication manager 1110, and station wireless communication manager 1200 may, individually or collectively, be implemented with at least one ASIC adapted to perform some or all of the applicable features in hardware. Alternatively, the features may be performed by one or more other processing units (or cores), on at least one IC. In other examples, other types of integrated circuits may be used (e.g., Structured/Platform ASICs, a FPGA, or another semi-custom IC), which may be programmed in any manner known in the art. The features may also be implemented, in whole or in part, with instructions embodied in a memory, formatted to be executed by one or more general or application-specific processors.

FIG. 13 shows a diagram of a system 1300 including a device that supports dynamic DTIM implementations in accordance with various aspects of the present disclosure. For example, system 1300 may include station 115-e, which may be an example of a wireless communication device 1000, a wireless communication device 1100, or a station 115 as described with reference to FIGS. 1, 2 and 10 through 12. The station 115-e may include a station wireless communication manager 1305, memory 1310, processor 1320, transceiver 1325, and an antenna 1330. Each of these modules may communicate, directly or indirectly, with one another (e.g., via one or more buses). The station wireless communication manager 1305 may be an example of a station wireless communication manager as described with reference to FIGS. 10 through 12.

The memory 1310 may include RAM and ROM. The memory 1310 may store computer-readable, computer-executable software or firmware code 1315 including instructions that, when executed by the processor, cause the station 115-e to perform various functions described herein (e.g., dynamic DTIM implementations, etc.). In some cases, the code 1315 may not be directly executable by the processor but may cause a computer (e.g., when compiled and executed) to perform functions described herein. The processor 1320 may include an intelligent hardware device, (e.g., a CPU, a microcontroller, an ASIC, etc.)

The transceiver 1325 may communicate bi-directionally, via one or more antennas, wired, or wireless links, with one or more networks, as described above. For example, the transceiver 1325 may communicate bi-directionally with an AP 105 or a station 115. The transceiver 1325 may also include a modem to modulate the packets and provide the modulated packets to the antennas for transmission, and to demodulate packets received from the antennas. In some cases, the wireless communication device may include a single antenna 1330. However, in some cases the device may have more than one antenna 930, which may be capable of concurrently transmitting or receiving multiple wireless transmissions.

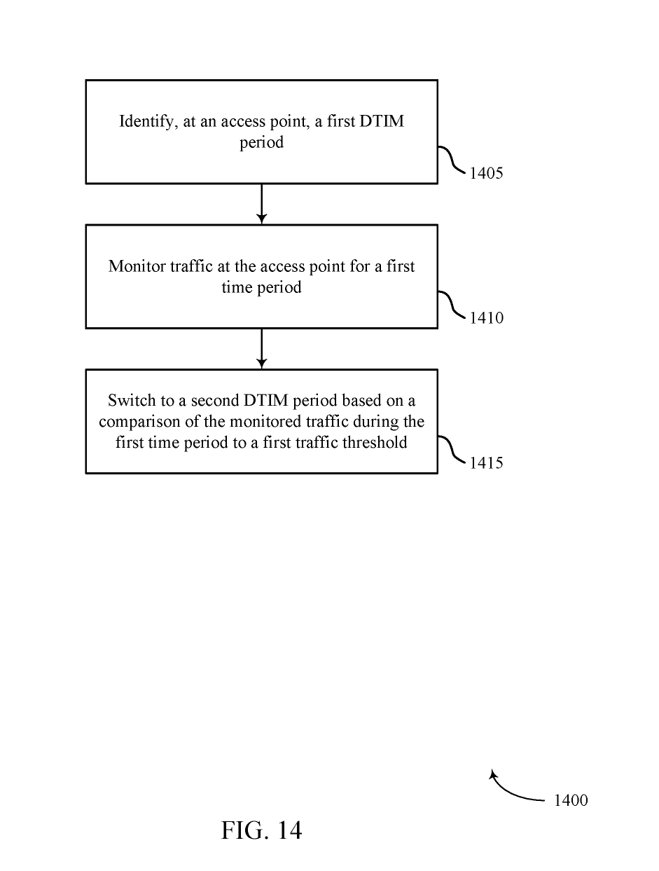

FIG. 14 shows a flowchart illustrating a method 1400 for dynamic DTIM implementations in accordance with various aspects of the present disclosure. The operations of method 1400 may be implemented by a device such as a AP 105 or its components as described with reference to FIGS. 1 through 4, and 6 through 9. For example, the operations of method 1400 may be performed by the AP wireless communication manager as described herein. In some examples, the AP 105 may execute a set of codes to control the functional elements of the device to perform the functions described below. Additionally or alternatively, the AP 105 may perform aspects the functions described below using special-purpose hardware.

At block 1405, the AP 105 may identify, at an access point, a first DTIM period as described above with reference to FIGS. 2 through 4. In certain examples, the operations of block 1405 may be performed by the DTIM period manager 715 as described with reference to FIG. 7 or the DTIM period manager 810 as described with reference to FIG. 8.

At block 1410, the AP 105 may monitor traffic at the access point for a first time period as described above with reference to FIGS. 2 through 4. In certain examples, the operations of block 1410 may be performed by the AP traffic monitor 720 as described with reference to FIG. 7 or the AP traffic monitor 815 as described with reference to FIG. 8.

At block 1415, the AP 105 may switch to a second DTIM period based on a comparison of the monitored traffic during the first time period to a first traffic threshold as described above with reference to FIGS. 2 through 4. In certain examples, the operations of block 1415 may be performed by the DTIM period manager 715 as described with reference to FIG. 7 or the DTIM period manager 810 as described with reference to FIG. 8.

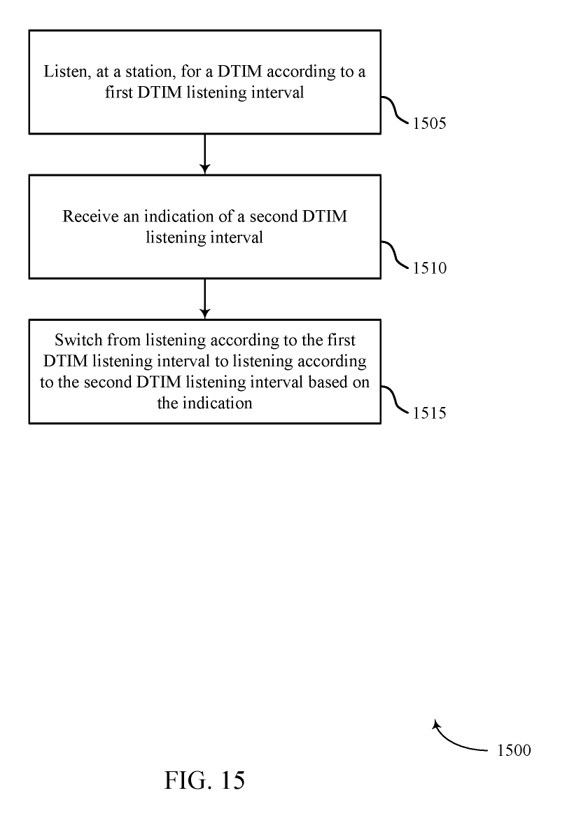

FIG. 15 shows a flowchart illustrating a method 1500 for dynamic DTIM implementations in accordance with various aspects of the present disclosure. The operations of method 1500 may be implemented by a device such as a station 115 or its components as described with reference to FIGS. 1 through 3, 5, and 10 through 13. For example, the operations of method 1500 may be performed by the station wireless communication manager as described herein. In some examples, the station 115 may execute a set of codes to control the functional elements of the device to perform the functions described below. Additionally or alternatively, the station 115 may perform aspects the functions described below using special-purpose hardware.

At block 1505, the station 115 may listen, at a station, for a DTIM according to a first DTIM listening interval as described above with reference to FIGS. 2, 3, and 5. In certain examples, the operations of block 1505 may be performed by the station power mode manager 1115 as described with reference to FIG. 11 or the station power mode manager 1215 as described with reference to FIG. 12.

At block 1510, the station 115 may receive an indication of a second DTIM listening interval as described above with reference to FIGS. 2, 3, and 5. In certain examples, the operations of block 1510 may be performed by the TIM interpreter 1120 as described with reference to FIG. 11 or the TIM interpreter 1210 as described with reference to FIG. 12.

At block 1515, the station 115 may switch from listening according to the first DTIM listening interval to listening according to the second DTIM listening interval based on the indication as described above with reference to FIGS. 2, 3, and 5. In certain examples, the operations of block 1515 may be performed by the station power mode manager 1115 as described with reference to FIG. 11 or the station power mode manager 1215 as described with reference to FIG. 12.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for dynamic DTIM implementations.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The various illustrative blocks and modules described in connection with the disclosure herein may be implemented or performed with a general-purpose processor, a DSP, an ASIC, a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration). Thus, the functions described herein may be performed by one or more other processing units (or cores), on at least one IC. In various examples, different types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Thus, aspects of the disclosure may provide for dynamic DTIM implementations. It should be noted that these methods describe possible implementations, and that the operations and the steps may be rearranged or otherwise modified such that other implementations are possible. In some examples, aspects from two or more of the methods may be combined.

What is claimed is:

1. An apparatus for wireless communication, comprising:
a processor;
memory in electronic communication with the processor; and
instructions stored in the memory and operable, when executed by the processor, to cause the apparatus to:
identify, at an access point, a first delivery traffic indication message (DTIM) period;
monitor traffic at the access point for a first time period; and
switch to a second DTIM period based at least in part on a comparison of the monitored traffic during the first time period to a first traffic threshold.

2. The apparatus of claim 1, wherein the instructions are operable to cause the processor to:
transmit a plurality of DTIMs in a plurality of beacon frames according to the second DTIM period.

3. The apparatus of claim 1, wherein the instructions are operable to cause the processor to:
determine that a value representing the monitored traffic for the first time period is below the first traffic threshold; and
switch to the second DTIM period, the second DTIM period being longer than the first DTIM period.

4. The apparatus of claim 3, wherein the instructions are operable to cause the processor to:
identify an absence of traffic during the first time period for the access point to attempt to transmit to one or more stations.

5. The apparatus of claim 3, wherein the instructions are operable to cause the processor to:
detect traffic at the access point during a second time period; and
switch back to the first DTIM period based at least in part on detecting the traffic during the second time period.

6. The apparatus of claim 3, wherein the instructions are operable to cause the processor to:
monitor traffic at the access point for a second time period; and
switch to a third DTIM period based at least in part on a second comparison of the monitored traffic during the second time period to a second traffic threshold, the third DTIM period being longer than the second DTIM period.

7. The apparatus of claim 1, wherein the instructions are operable to cause the processor to:
determine that a value representing the monitored traffic for the first time period is above the first traffic threshold; and
switch to the second DTIM period, the second DTIM period being shorter than the first DTIM period.

8. The apparatus of claim 7, wherein the instructions are operable to cause the processor to:
identify traffic at the access point.

9. The apparatus of claim 1, wherein the instructions are operable to cause the processor to:
generate a DTIM period value according to the second DTIM period; and
transmit the DTIM period value.

10. The apparatus of claim 9, wherein the instructions are operable to cause the processor to:
determine that a DTIM count is zero; and
wherein transmitting the DTIM period value comprises transmitting the DTIM period value based at least in part on determining that the DTIM count is zero.

11. The apparatus of claim 1, wherein the second DTIM period is an integer multiple of the first DTIM period.

12. An apparatus for wireless communication, comprising:
a processor;
memory in electronic communication with the processor; and
instructions stored in the memory and operable, when executed by the processor, to cause the apparatus to:
listen, at a station, for a delivery traffic indication message (DTIM) according to a first DTIM listening interval;
receive an indication of a second DTIM listening interval; and
switch from listening according to the first DTIM listening interval to listening according to the second DTIM listening interval based at least in part on the indication.

13. The apparatus of claim 12, wherein the instructions are operable to cause the processor to:
determine a wake-up configuration of the station based at least in part on the second DTIM listening interval.

14. The apparatus of claim 12, wherein the instructions are operable to cause the processor to:
receive a second indication of a third DTIM listening interval; and
switch from listening according to the second DTIM listening interval to listening according to the third DTIM listening interval based at least in part on the second indication.

15. The apparatus of claim 12, wherein the second DTIM listening interval is longer than the first DTIM listening interval.

16. The apparatus of claim 12, wherein the second DTIM listening interval is an integer multiple of the first DTIM listening interval.

17. The apparatus of claim 12, wherein the instructions are operable to cause the processor to:
listen for a DTIM comprises decoding a portion of a beacon frame transmitted by an access point.

18. The apparatus of claim 12, wherein the instructions are operable to cause the processor to:
receive a DTIM count information element, or a DTIM period information element, or a combination thereof.

19. A method of wireless communication comprising:
identifying, at an access point, a first delivery traffic indication message (DTIM) period;
monitoring traffic at the access point for a first time period; and
switching to a second DTIM period based at least in part on a comparison of the monitored traffic during the first time period to a first traffic threshold.

20. The method of claim 19, further comprising:
transmitting a plurality of DTIMs in a plurality of beacon frames according to the second DTIM period.

21. The method of claim 19, wherein switching to the second DTIM period comprises:
determining that a value representing the monitored traffic for the first time period is below the first traffic threshold; and
switching to the second DTIM period, the second DTIM period being longer than the first DTIM period.

22. The method of claim 21, further comprising:
detecting traffic at the access point during a second time period; and
switching back to the first DTIM period based at least in part on detecting the traffic during the second time period.

23. The method of claim 21, further comprising:
monitoring traffic at the access point for a second time period; and
switching to a third DTIM period based at least in part on a second comparison of the monitored traffic during the second time period to a second traffic threshold, the third DTIM period being longer than the second DTIM period.

24. The method of claim 19, wherein switching to the second DTIM period comprises:
determining that a value representing the monitored traffic for the first time period is above the first traffic threshold; and
switching to the second DTIM period, the second DTIM period being shorter than the first DTIM period.

25. The method of claim 19, further comprising:
generating a DTIM period value according to the second DTIM period; and
transmitting the DTIM period value.

26. A method of wireless communication comprising:
listening, at a station, for a delivery traffic indication message (DTIM) according to a first DTIM listening interval;
receiving an indication of a second DTIM listening interval; and
switching from listening according to the first DTIM listening interval to listening according to the second DTIM listening interval based at least in part on the indication.

27. The method of claim 26, further comprising:
determining a wake-up configuration of the station based at least in part on the second DTIM listening interval.

28. The method of claim 26, further comprising:
receiving a second indication of a third DTIM listening interval; and
switching from listening according to the second DTIM listening interval to listening according to the third DTIM listening interval based at least in part on the second indication.

29. The method of claim 26, further comprising:
listening for a DTIM comprises decoding a portion of a beacon frame transmitted by an access point.

30. The method of claim 26, wherein receiving the indication of the second DTIM listening interval comprises receiving a DTIM count information element, or a DTIM period information element, or a combination thereof.
